(19) United States
(12) Patent Application Publication
(10) Pub. No.: US 2014/0334189 A1
(43) Pub. Date: Nov. 13, 2014

(54) BI-DIRECTIONAL DC-DC CONVERTER

(71) Applicant: DELTA ELECTRONICS, INC., Taoyuan Hsien (TW)

(72) Inventors: Chao YAN, Taoyuan Hsien (TW); Mi CHEN, Taoyuan Hsien (TW); Cai YANG, Taoyuan Hsien (TW)

(73) Assignee: DELTA ELECTRONICS, INC., Taoyuan Hsien (TW)

(21) Appl. No.: 14/079,752

(22) Filed: Nov. 14, 2013

(30) Foreign Application Priority Data
May 7, 2013 (CN) 201310164929.3

(51) Int. Cl. H02M 3/337; H02M 3/335

(52) U.S. Cl. CPC H02M 3/337; H02M 3/33538
USPC 363/17

(57) ABSTRACT

The present disclosure discloses a bi-directional DC-DC converter, comprising a primary-side inverting/rectifying module, an isolated transformer, and a secondary-side rectifying/inverting module, wherein the primary-side inverting/rectifying module comprises a first bridge arm composed of a first switching component and a second switching component connected in series and a clamping circuit comprising a resonant inductor and a clamping bridge arm composed of a first semiconductor component and a second semiconductor component connected in series, and two terminals of the resonant inductor are respectively coupled to a common node of the first switching component and the second switching component and a common node of the first semiconductor component and the second semiconductor component. The present disclosure can improve transformer efficiency while achieving the soft switching of the switching components.

### CROSS REFERENCE TO RELATED APPLICATIONS

This application claims the priority to and the benefit of Chinese Patent Application No. 201310164929.3, filed May 7, 2013 and entitled “bi-directional DC-DC converter” which is incorporated herein by reference in its entirety.

### TECHNICAL FIELD

The present disclosure relates generally to a converter, and particularly to a bidirectional DC-DC (direct current-direct current) converter.

### BACKGROUND ART

Isolated bi-directional DC-DC converters have important applications in electronic devices with energy-storage batteries, and so on, and play a role of bridge in exchanging energy between the batteries and DC buses. There are some technical problems in the applications of a low-voltage side current-fed and high-voltage side voltage-fed isolated bi-directional DC-DC converter.

For example, in an application of using a battery as backup power, since the battery voltage is generally lower than a DC bus voltage, the bi-directional DC-DC converter functions as charging and discharging the battery. In comparison with a non-isolated bi-directional DC-DC converter, the isolated bi-directional DC-DC converter can achieve an electrical isolation, and also can achieve a higher transformation ratio. K. Wang, C. Y. Lin et al. disclosed a low-voltage side current-fed and high-voltage side voltage-fed bi-directional DC-DC converter with active clamp (see “Bidirectional DC to DC converters for fuel cell systems”, Power Electronics in Transportation, 1998, pp. 47-51), which achieves voltage clamping and soft switching of some switching components by the operation of the active-clamp switching components in corporation with the switching components in the bridge arms.

However, such switching components for achieving the soft-switching operation depend highly on the active-clamp switching components, and the active-clamp switching components per se are hard switching, which additionally increases current of switching components in the bridge arms. As an improvement, Tsai-Fu Wu, Yung-Chu Chen, et al. proposed an isolated bi-directional DC-DC converter (see “Isolated bidirectional full-bridge DC-DC converter with a flyback snubber”, Power Electronics, IEEE Transactions on, vol. 25, pp. 1915-1922, 2010), in which the converter achieves the soft switching by using a flyback snubber in corporation with leakage inductances in a transformer. Although this snubber is independent from a power circuit and the clamping voltage can be set, it is required to use leakage inductances in transformer to achieve the soft switching of the switching components in the bridge arms, which may affect transfer efficiency of the transformer to a certain extent.

### SUMMARY

To solve the above-mentioned problems, an object of the present disclosure is to provide a bi-directional DC-DC converter which, in part, may improve efficiency of the transformer while achieving soft switching of the switching components therein.

In one aspect, the bi-directional DC-DC converter of the present disclosure comprises: a primary-side inverting/rectifying module, two terminals of the primary-side inverting/rectifying module at a primary side being coupled to a first DC port, for receiving a DC power from the first DC port or outputting a DC power to the first DC port; an isolated transformer, comprising a primary winding and a secondary winding, two terminals of the primary winding being respectively coupled to two terminals of the primary-side inverting/rectifying module at a secondary side; a secondary-side rectifying/inverting module, comprising at least a switching component, wherein two terminals of the secondary-side rectifying/inverting module at the primary side are respectively coupled to two terminals of the secondary winding and two terminals of the secondary-side rectifying/inverting module at the secondary side are respectively coupled to a second DC port, and the secondary-side rectifying/inverting module rectifying energy from the isolated transformer and outputting the rectified current to the second DC port, or receiving a DC power from the second DC port; wherein the primary-side inverting/rectifying module comprises a first bridge arm composed of a first switching component and a second switching component connected in series and a clamping circuit comprising a resonant inductor and a clamping bridge arm composed of a first semiconductor component and a second semiconductor component connected in series, and two terminals of the resonant inductor are respectively coupled to a common node of the first switching component and the second switching component and a common node of the first semiconductor component and the second semiconductor component.

The topology with bi-directional energy transfer proposed by the present disclosure can achieve the soft switching of the switching components in the bridge arms by employing an additional resonant inductor and a clamping diode, and not relying on leakage inductances in the transformer, which enables the leakage inductances in transformer to be designed to a minimum and facilitates to improve efficiency of transformer. Furthermore, voltage in the bridge arms may be effectively clamped by using the clamping diode in the present disclosure, and voltage spikes may be confined.

These and other aspects of the present disclosure will become apparent from the following description of the preferred embodiment taken in conjunction with the following drawings, although variations and modifications therein may be effected without departing from the spirit and scope of the novel concepts of the disclosure.

The foregoing summary is not intended to summarize each potential embodiment or every aspect of the present disclosure.

### BRIEF DESCRIPTION OF THE DRAWINGS

The accompanying drawings illustrate one or more embodiments of the disclosure and together with the written description, serve to explain the principles of the disclosure. Wherever possible, the same reference numbers are used throughout the drawings to refer to the same or like elements of an embodiment, and wherein:

FIG. 1 is an illustrative structural block diagram of a bi-directional DC-DC converter according to the present disclosure;

FIG. 2 is an illustrative circuit diagram of a bi-directional DC-DC converter according to a first embodiment of the present disclosure;

FIG. 3 is an illustrative circuit diagram of the bi-directional DC-DC converter further comprising a control circuit according to the first embodiment of the present disclosure;

FIG. 4 is an illustrative functional diagram of a control module in the control circuit shown in FIG. 3;

FIG. 5 is an illustrative diagram showing a circuit waveform when energy is transferred from a high-voltage side to a low-voltage side in the case of applying a high-frequency switching signal to a single side of the bi-directional DC-DC converter according to the first embodiment of the present disclosure;

FIGS. 6-15 are illustrative circuit diagrams showing an operation principle when energy is transferred from a high-voltage side to a low-voltage side in the case of applying a high-frequency switching signal to a single side of the bi-directional DC-DC converter according to the first embodiment of the present disclosure;

FIG. 16 is an illustrative diagram showing a circuit waveform when energy is transferred from a low-voltage side to a high-voltage side in the case of applying a high-frequency switching signal to a single side of the bi-directional DC-DC converter according to the first embodiment of the present disclosure;

FIGS. 17-20 are illustrative circuit diagrams showing an operation principle when energy is transferred from a low-voltage side to a high-voltage side in the case of applying a high-frequency switching signal to a single side of the bi-directional DC-DC converter according to the first embodiment of the present disclosure;

FIG. 21 is an illustrative diagram showing a circuit waveform when energy is transferred from a high-voltage side to a low-voltage side in the case of applying a high-frequency switching signal to two sides of the bi-directional DC-DC converter according to the first embodiment of the present disclosure;

FIGS. 22-31 are illustrative circuit diagrams showing an operation principle when energy is transferred from a high-voltage side to a low-voltage side in the case of applying a high-frequency switching signal to two sides of the bi-directional DC-DC converter according to the first embodiment of the present disclosure;

FIG. 32 is an illustrative diagram showing a circuit waveform when energy is transferred from a low-voltage side to a high-voltage side in the case of applying a high-frequency switching signal to two sides of the bi-directional DC-DC converter according to the first embodiment of the present disclosure;

FIGS. 33-39 are illustrative circuit diagrams showing an operation principle when energy is transferred from a low-voltage side to a high-voltage side in the case of applying a high-frequency switching signal to two sides of the bi-directional DC-DC converter according to the first embodiment of the present disclosure;

FIG. 40 is an illustrative circuit diagram of a bi-directional DC-DC converter according to a second embodiment of the present disclosure;

FIG. 41 is an illustrative diagram showing a circuit waveform when energy is transferred from a high-voltage side to a low-voltage side in the bi-directional DC-DC converter according to the second embodiment of the present disclosure;

FIG. 42 is an illustrative diagram showing a circuit waveform when energy is transferred from a low-voltage side to a high-voltage side in the bi-directional DC-DC converter according to the second embodiment of the present disclosure;

FIG. 43 is an illustrative circuit diagram of a bi-directional DC-DC converter according to a third embodiment of the present disclosure;

FIG. 44 is an illustrative circuit diagram of a bi-directional DC-DC converter according to a fourth embodiment of the present disclosure;

Specific embodiments in this disclosure have been shown by way of example in the foregoing drawings and are hereinafter described in detail. The figures and written description are not intended to limit the scope of the inventive concepts in any manner. Rather, they are provided to illustrate the inventive concepts to a person skilled in the art by reference to particular embodiments.

### DETAILED DESCRIPTION

Hereinafter, the embodiments of the present disclosure are described in detail. It should be noted that the embodiments are only illustrative, not limit the present disclosure.

The present disclosure will now be described more fully hereinafter with reference to the accompanying drawings, in which exemplary embodiments of the disclosure are shown. This disclosure may, however, be embodied in many different forms and should not be construed as limited to the embodiments set forth herein. Rather, these embodiments are provided so that this disclosure will be thorough and complete, and will fully convey the scope of the disclosure to those skilled in the art. Like reference numerals refer to like elements throughout.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” or “includes” and/or “including” or “has” and/or “having” when used herein, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

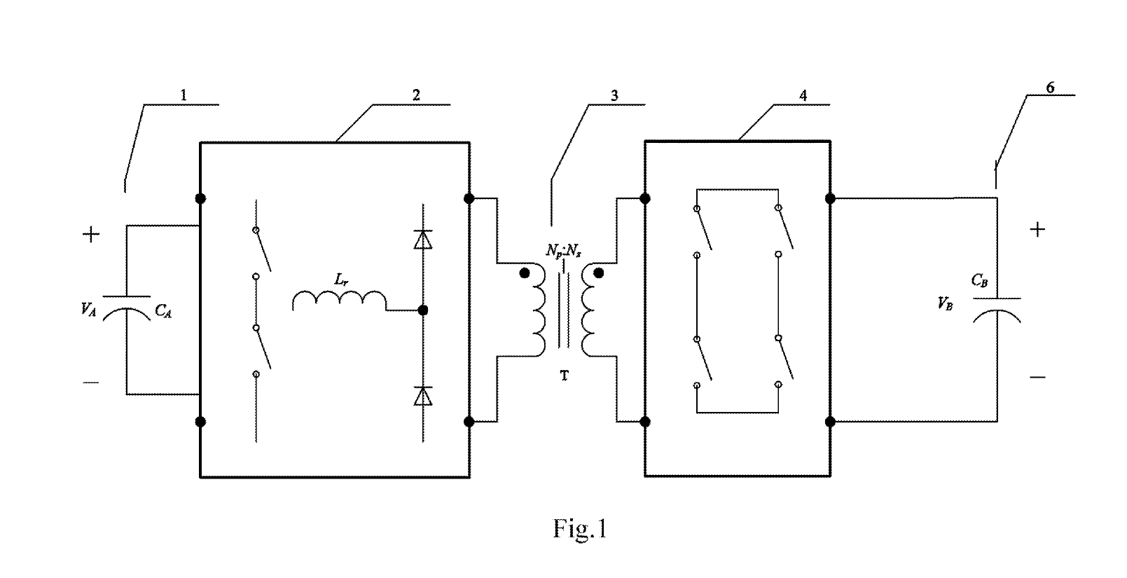

A bi-directional DC-DC converter provided by the present disclosure has a topology as shown in FIG. 1, comprising, from left to right, a primary-side DC port 1, a primary-side inverting/rectifying module 2, an isolated transformer 3, a secondary-side rectifying/inverting module 4, and a secondary-side DC port 6.

Two terminals of the primary-side inverting/rectifying module 2 at the primary side are coupled to a first DC voltage source located at the primary-side DC port 1, and are used to receive a direct current (DC) power from the primary-side DC port 1 or output a DC power to the primary-side DC port 1.

The isolated transformer 3 includes a primary winding and a secondary winding, and two terminals of the primary winding are respectively coupled to two terminals of the primary-side inverting/rectifying module 2 at the secondary side.

The secondary-side rectifying/inverting module 4 includes at least a switching component. Two terminals of the secondary-side rectifying/inverting module 4 at the primary side are respectively coupled to two terminals of the secondary winding of the isolated transformer 3, and two terminals of the secondary-side rectifying/inverting module 4 at the secondary side are coupled to the secondary-side DC port 6. The secondary-side rectifying/inverting module 4 rectifies energy from the isolated transformer 3 and outputs the rectified current to a second DC voltage source located at the secondary-side DC port 6, or receives a DC power from the second DC voltage source at the secondary-side DC port 6. As shown in FIG. 1, a clamping circuit including a separate resonant inductor is employed in the primary-side inverting/rectifying module 2, so as to achieve soft-switching of the switch components and voltage clamp in the primary-side inverting/rectifying module. Such manner does not depend on leakage inductance of the transformer, and thus the leakage inductance of the transformer may be designed to a minimum, thereby facilitating to improve efficiency of the transformer. Further, the clamping circuit can effectively clamp voltage across a bridge arm and thus confine voltage spikes across the switching components, thereby protecting the switching components.

In particularly, the primary-side inverting/rectifying module 2 includes a first bridge arm composed of two switching components connected in series and a clamping circuit. The clamping circuit includes a resonant inductor and a clamping bridge arm composed of two clamping switching components connected in series, wherein one terminal of the resonant inductor is connected to a midpoint of the clamping bridge arm, and the other terminal of the resonant inductor is connected to a midpoint of the first bridge arm.

The secondary-side rectifying/inverting module 4 includes a full-bridge bi-directional rectifier bridge including two bridge arms, each of which is composed of switching components connected in series. Those skilled in the art should understand that the secondary-side rectifying/inverting module may also include other types of bi-directional rectifier bridge structure, such as a bi-directional rectifier bridge with push-pull structure or full-wave structure, according to particular applications.

The bi-directional DC-DC converter of the present disclosure may operate in one of the following two states: in a first state, energy is transferred from the primary side to the secondary side; and in a second state, energy is transferred from the secondary side to the primary side.

When the bi-directional DC-DC converter operates in the first state, the primary side inverting/rectifying module 2 receives and inverts energy from the primary-side DC port 1 (i.e., DC-AC), then the isolated transformer 3 transfers the inverted energy from the primary side to the secondary side, and thereafter, the secondary-side rectifying/inverting module 4 rectifies and filters energy received from the isolated transformer 3 (AC-DC), so as to generate a DC output at the secondary-side DC port 6.

When the bi-directional DC-DC converter operates in the second state, energy from the secondary-side DC port 6 is transferred to the secondary-side rectifying/inverting module 4, the secondary-side rectifying/inverting module 4 inverts the received energy (i.e., DC-AC), and the inverted energy is then transferred from the secondary side to the primary side by the isolated transformer 3, and rectified by the primary-side inverting/rectifying module 2 so as to generate a DC output at the primary-side DC port 1.

A driving signal can be separately applied to the primary side or the secondary side of the bi-directional DC-DC converter in order to achieve bi-directional transfer of energy. For example, when energy is transferred from the primary side to the secondary side, a control circuit may only output a driving signal to the switching components at the primary side; and when energy is transferred from the secondary side to the primary side, the control circuit may only output a driving signal to the switching components at the secondary side.

Additionally, when the bi-directional DC-DC converter switches between the two states, in order to quickly switch the transfer direction of energy in the converter, the driving signal may be applied to the switching components both at the primary side and at the secondary side simultaneously.

Therefore, the bi-directional DC-DC converter of the present disclosure further includes a control circuit for generating a driving signal to the switching components in the primary-side inverting/rectifying module and the secondary-side rectifying/inverting module. In one embodiment, the control circuit may output the driving signal in real time to the primary-side inverting/rectifying module and the secondary-side rectifying/inverting module according to the DC signal in the converter so that the converter outputs an appropriate DC power.

### Embodiment 1

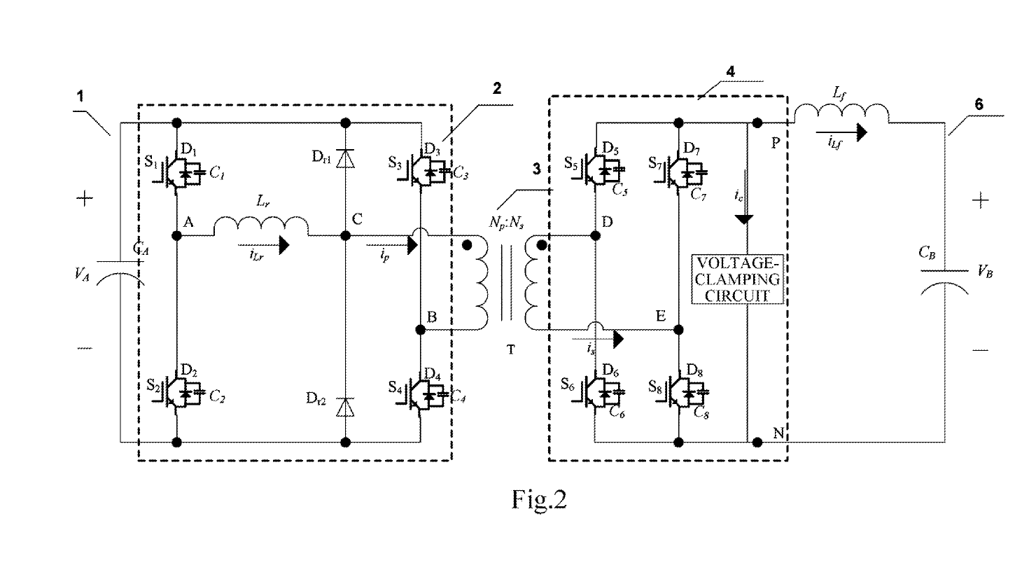

Hereafter, a first embodiment of the present disclosure will be described with reference to FIGS. 2-39.

FIG. 2 shows a circuit diagram of a bi-directional DC-DC converter according to the first embodiment of the present disclosure.

In the first embodiment of the present disclosure, the bi-directional DC-DC converter includes a primary-side DC port 1, a primary-side inverting/rectifying module 2, an isolated transformer 3, a secondary-side rectifying/inverting module 4, and a secondary-side DC port 6.

As shown in FIG. 2, the primary-side inverting/rectifying module 2 includes a first bridge arm and a clamping circuit. The first bridge arm is composed of switching components S₁ and S₂ connected in series, and receives a voltage V_{A} from the primary-side DC port via a capacitor C_{A} at high-pressure side which is connected in parallel with the first bridge arm. The clamping circuit includes a resonant inductor Lr and a clamping bridge arm composed of semiconductor devices Dᵣ₁ and Dᵣ₂ connected in series. One terminal of the resonant inductor Lr is connected to a midpoint A (i.e. a common node A of the switching components S₁ and S₂) of the first bridge arm, and the other terminal of the resonant inductor Lr is connected to a midpoint C (i.e. a common node C of the semiconductor devices Dᵣ₁ and Dᵣ₂) of the clamping bridge arm.

In this embodiment, although the semiconductor devices Dᵣ₁ and Dᵣ₂ connected in series are implemented by diodes, it should be understood that the present disclosure is not limited to this, and the semiconductor devices Dᵣ₁ and Dᵣ₂ may be other types of switching components, such as MOSFET and IGBT.

In addition, the primary-side inverting/rectifying module 2 further includes a second bridge arm composed of switching components S₃ and S₄ connected in series. The second bridge arm, the first bridge arm, and the clamping bridge arm are connected in parallel with the primary-side DC port 1, so as to achieve the inverting/rectifying function at the primary side.

The isolated transformer is a transformer T including a primary-side winding (that is, a primary winding) and a secondary-side winding (that is, a secondary winding), and the turn ratio of the primary winding to the secondary winding is Np:Ns, and may be determined according to a step-up ratio or a step-down ratio. Two terminals of the primary winding of the transformer T are respectively connected to a midpoint B (i.e. a common node B of the switching component S₃ and S₄) of the second bridge arm and the midpoint C of the clamping bridge arm. The secondary winding of the transformer T is connected to the secondary-side rectifying/inverting module 4.

In this embodiment, the secondary-side rectifying/inverting module 4 includes a bi-directional full-bridge rectifier bridge including two bridge arms connected in parallel, each of which is respectively composed of switching components S₅, S₆ connected in series and S₇, S₈ connected in series, and two terminals of the secondary winding in the transformer T are respectively connected to midpoints D and E of the two bridge arms. Those skilled in the art should understand that the secondary-side rectifying/inverting module may also include other types of bi-directional rectifier bridge structure, such as a bi-directional rectifier with a push-pull structure or a full-wave structure, according to particular applications.

Considering leakage inductances existing in an actual transformer (although the topology of the present disclosure may reduce the leakage inductances of the transformer as much as possible, there still exist relatively small leakage inductances), the secondary-side rectifying/inverting module further includes a voltage-clamping circuit which is connected in parallel with the secondary-side rectifying/inverting module to absorb voltage spike across the switching components in the secondary-side rectifying/inverting module. The voltage-clamping circuit at the secondary side may be implemented in various manners, for example, may employ a RCD clamping circuit with a simple structure.

Further, the bi-directional DC-DC converter of the present disclosure may also include a filtering inductor L_{f} at the secondary side which is connected in series with the secondary-side rectifying/inverting module and coupled to a DC capacitor C_{B} at the secondary side so as to filter the current rectified by the secondary-side rectifying/inverting module.

In addition, taking magnetic bias into account, a blocking capacitor is serially connected to the transformer windings at the high-voltage side, for example, a blocking capacitor is serially connected at a connection between the transformer T and a node B or a node C. For ease of description, the magnetic bias and the leakage inductances of the transformer will not be considered in the analysis of the specific operating states described later.

Further, backward diodes (anti-parallel diodes) and capacitors are connected in parallel with the switching components as shown in FIG. 2, wherein the parallel capacitor is a resonant capacitor for achieving soft switching function together with the resonant inductor Lr, and generally is a junction capacitance of the switching component or may be a sum of the junction capacitance and an external capacitance; the anti-parallel diode is a freewheeling diode providing a flow path for the reverse current, and is generally integrated in the switching component or may be an additional diode.

In the present disclosure, the primary-side DC port may be a high-voltage port or a low-voltage port with respect to the secondary-side DC port, that is, the bi-directional DC-DC converter of the present disclosure may be a boost converter or a buck converter. For example, in the case of a battery application where the battery voltage is relatively low and the battery has some limitation to a current ripple, if the battery is located at the secondary-side DC port, the primary-side DC port is a high-voltage port and the secondary-side DC port is a low-voltage port.

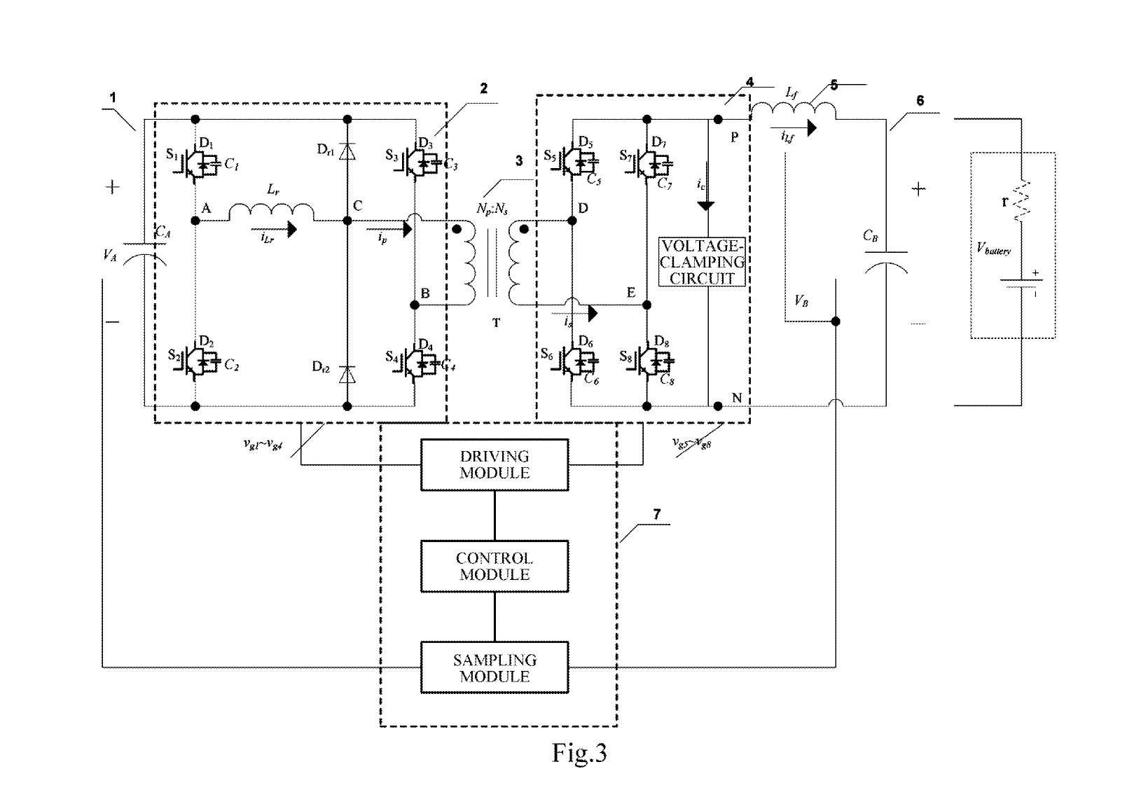

As shown in FIG. 3, in order to control energy transfer in the bi-directional DC-DC converter, the present disclosure also includes a control circuit 7 for generating a driving signal to the switching components in the primary-side inverting/rectifying module 1 and the secondary-side rectifying/inverting module 4.

In one embodiment, the control circuit 7 may output a driving signal in real time to the primary-side inverting/rectifying module and the secondary-side rectifying/inverting module according to a DC signal in the converter, so as to perform energy transfer and conversion according to requirements. For example, the control circuit 7 controls transfer direction of energy, especially transfer direction of energy in a stable state, by controlling certain signals (e.g., current direction of a filtering inductor 5 shown in FIG. 3) in the converter. Herein, the stable state means a state where the converter maintains a constant output on the condition of a certain input, for example, a state where the converter maintains a constant output more than 100 switching cycles. Accordingly, in order to implement the above control of transfer direction of energy, the control circuit 7 in this embodiment may include a sampling module, a control module, and a driving module.

In this embodiment, the sampling module samples a DC signal (a current signal or a voltage signal) in the converter circuit, and transmits the sampled signal to the control module. Then the control module processes the sampled signal to generate a corresponding control signal, and outputs the control signal to the driving module. Afterwards, the driving module outputs a corresponding driving signal to respective switching components at the primary side and the secondary side according to the control signal generated by the control module. For example, when energy is transferred from the primary side to the secondary side, the driving module may output a high-frequency driving signal to switching components at the primary side and output a constant low-level driving signal to switching components at the secondary side, according to the control signal generated by the control module. When energy is transferred from the secondary side to the primary side, the driving module may output a high-frequency driving signal to switching components at the secondary side and output a constant low-level driving signal to switching components at the primary side, according to the control signal generated by the control module. Of course, if the converter continues to switch between two states of energy transfer, in order to quicken this switching, the driving module may simultaneously output a high-frequency driving signal to the switching components both in the primary-side inverting/rectifying module and in the secondary-side rectifying/inverting module.

The control circuit 7 performs a control according to the desired control target. For example, when it is required to transfer energy to the secondary side, i.e., transfer the energy from the primary side to the secondary side, a signal (for example, an output voltage signal or current signal) at the secondary-side output port may be sampled so as to perform the control, typically according to energy transfer mode of a load connected at the secondary-side output port.

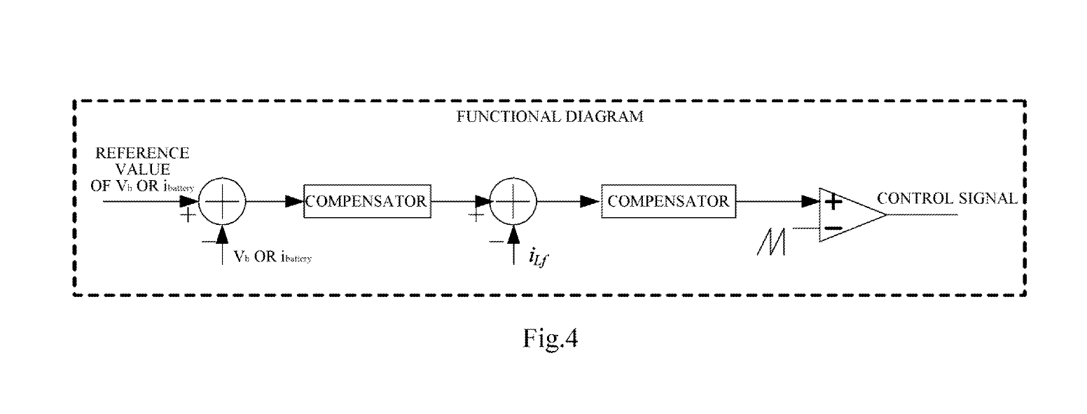

For example, if the load connected at the secondary side is a battery in a constant-current charging state, the current in the battery is used as the sampling target, which will be sampled by the sampling module and outputted to the control module. As shown in FIG. 4, in the control module, the sampled current signal is compared with a preset reference signal (for example, a desired charging current), and the compared result is processed by a proportional-integral controller (compensator) and an output of the compensator serves as a reference of current inner-loop. This reference is compared with a current i_{Lf} through the filtering inductor L_{f}, and the compared result is processed by the proportional-integral controller to generate a control signal such as PWM control signal. The PWM control signal passes through the driving module, and then generates different driving signals and these signals are outputted to the respective switching components. When the battery at the secondary-side output port is in constant-voltage charging state, a bus voltage at the secondary side is used as the control target. The bus voltage at the secondary side is sampled by the sampling module and then sent to the control module to be compared with a preset reference signal (e.g., a desired battery voltage). The compared result is processed by the proportional-integral controller (compensator) and an output of the compensator serves as a reference of current inner-loop. Thereafter, the reference is compared with the current i_{Lf} through the filtering inductor L_{f}, and the compared result is processed by the proportional-integral controller and the processed signal is outputted to generate the control signals such as PWM control signals. It should be emphasized that in a state where a battery is charged in constant voltage, the preset reference voltage of the battery should not be less than the current voltage of the battery, thereby ensuring that the battery is in the charge state.

Similarly, when it is required to transfer energy from the secondary side to the primary side, i.e., the energy flows from the secondary side to the primary side, the control to the transfer direction of energy is described by taking a battery connected to the secondary-side DC terminal as an example as well. When the battery at the secondary side operates in the constant-current state, the direction of energy transfer is controlled by setting current direction of the battery, for example, setting current direction of the filtering inductor L_{f}. When the battery operates in the constant-voltage state, the current direction of the battery may be determined by setting a desired battery voltage value. For example, when the desired battery voltage value is larger than the current voltage of the battery, the battery at the secondary side is in a charge state, which indicates that energy flows from the primary side to the secondary side. On the contrary, when the desired battery voltage value is smaller than the current voltage of the battery, the battery at the secondary side is in a discharge state, which indicates that energy flows from the secondary side to the primary side.

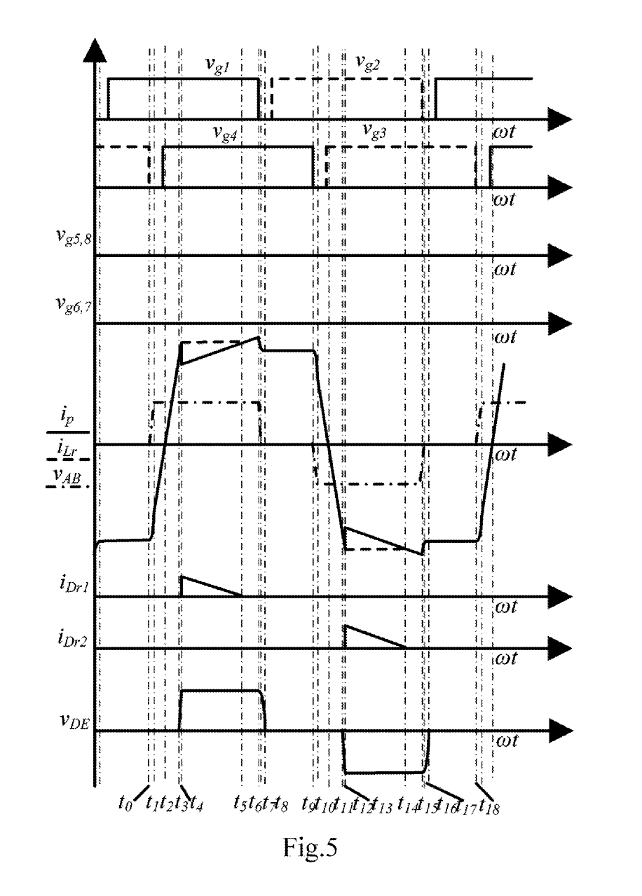

The operating states of the circuit shown in FIG. 3 will be described in detail with reference to FIGS. 5-39. Since in term of control, a high-frequency driving signal (i.e. switching signal) may be applied to only one of the primary side and the secondary side or be simultaneously applied to both of them, the two control situations will be described separately as below.

(1) an Example of Applying a High-Frequency Switching Signal to a Single Side

Assuming that the primary side is a high-voltage side and the secondary side is a low-voltage side, operation states of the circuit will be described in the case of applying a high-frequency switching signal to a single side. When energy is transferred from the high-voltage side to the low-voltage side, a high-frequency switching signals is only applied to the switching components S₁ to S₄ at the primary side, and the switching components S₅ to S₈ at the secondary side are always in an off state due to the application of low-level switching signals. When energy is transferred from the low-voltage side to the high-voltage side, a high-frequency switching signal is only applied to the switching components S₅ to S₈ at the secondary side, and the switching components S₁ to S₄ are always in an off state due to the application of low-level switching signals. Hereafter, different switching states in the different transfer direction of energy will be analyzed in detail in the case of applying high-frequency switching signals to a single side.

High-Voltage Side→Low-Voltage Side:

FIGS. 5-15 shows an operation principle that energy is transferred from the high-voltage side to the low-voltage side in the converter in the case of applying a high-frequency switching signal to a single side.

In vertical axis of FIG. 5, V_{g1}-V_{g4} represents voltages of the driving signals applied to the switching components S₁ to S₄ at the primary side, V_{g5}-V_{g8} represents voltages of the driving signals applied to the switching components S₅ to S₈ at the secondary side, iₚ represents a current flowing through two terminals of the transformer at the primary side (in this embodiment, high-voltage side), i_{Lr} represents a current flowing through the resonant inductor Lr, V_{AB} represents a voltage between a node A and a node B, i.e. a voltage outputted from the first bridge arm to the two terminals of the transformer at the primary side, V_{DE} represents an output voltage across two terminals of the transformer at the secondary side, i_{Dr1} represents a current flowing through a semiconductor component Dᵣ₁ in the clamping circuit, and i_{Dr2} represents a current flowing through a semiconductor component Dᵣ₂ in the clamping circuit. In horizontal axis of FIG. 5, t₀-t₁₈ represents different periods in a switching cycle.

Seen from FIG. 5, turn-on time of the switching components S₁ and S₂ of the first bridge arm is earlier than that of the switching component S₄ and S₃ of the second bridge arm. Thus, the first bridge arm composed of the switching components S₁ and S₂ is a leading leg, and the second bridge arm composed of the switching components S₄ and S₃ is a lagging leg.

In addition, further seen from FIG. 5, since the high-frequency driving signal is only applied to the high-voltage terminals at the primary side, V_{g1}-V_{g4} of the switching components S₁ to S₄ are high-frequency driving signals, and V_{g5}-V_{g8} of the switching components S₅ to S₈ are zero. It is noted that, although V_{g5}-V_{g8} of the switching components S₅ to S₈ are shown as zero for the ease of description, V_{g5}-V_{g8} of the switching components S₅ to S₈ are not necessarily zero, but may be low-level voltages lower than the turn-on voltages of the switching components S₅ to S₈.

With reference to FIG. 5, there are 18 switching states in the switching cycle when the high-frequency switching signal is only applied to the high-voltage side, and these switching states are respectively in the time periods of [before t₀], [t₀, t₁], [t₁, t₂], [t₂, t₃], [t₃, t₄], [t₄, t₅], [t₅, t₆], [t₆, t₇], [t₇, t₈], [t₈, t₉], [t₉, t₁₀], [t₁₀, t₁₁], [t₁₁, t₁₂], [t₁₂, t₁₃], [t₁₃, t₁₄], [t₁₄, t₁₅], [t₁₅, t₁₆], [t₁₆, t₁₇], and [t₁₇, t₁₈], wherein the switching states of [before t₀] and [t₁₇, t₁₈] describe the same state. Although only the operating principle of the switching states in the time periods of [before t₀]-[t₈, t₉] will be described hereafter, from the described switching states, those skilled in the art may understand the operating principle of other switching states in the switching cycle.

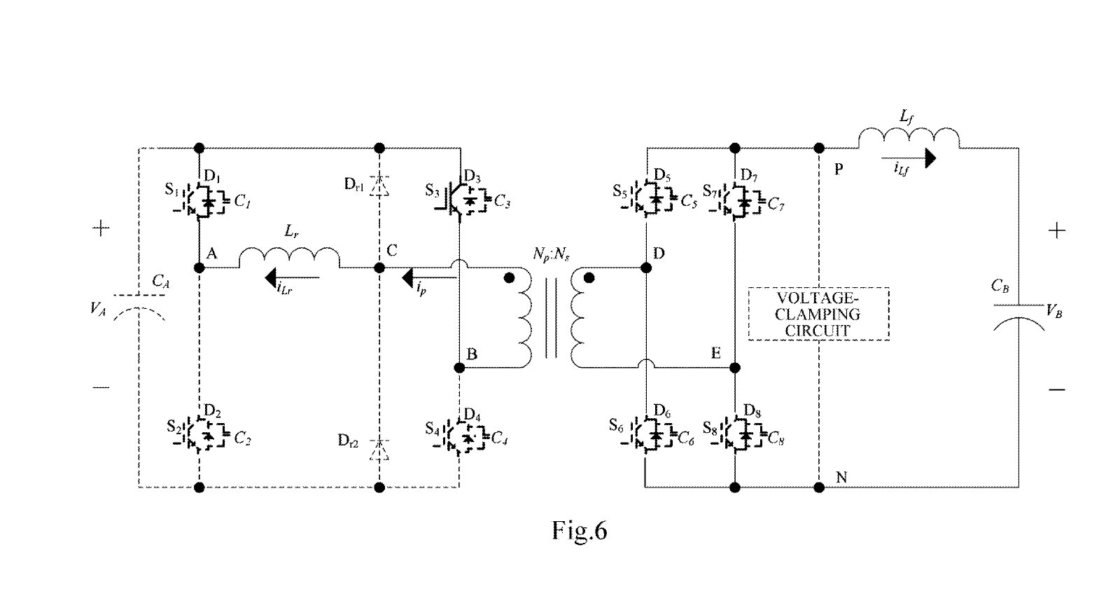

Switching state 1 [before t₀] (referring to FIG. 6)

As shown in FIG. 6, before the time of t₀, the switching components S₁ and S₃ are turned on, a current i_{Lr} through the resonant inductor Lr flows through an anti-parallel diode D₁ of the switching component S₁ and the switching component S₃, and a current i_{Lf} through the filter inductor L_{f} at the low-voltage side flows through the anti-parallel diodes D₅˜D₈ so as to provide continuous current.

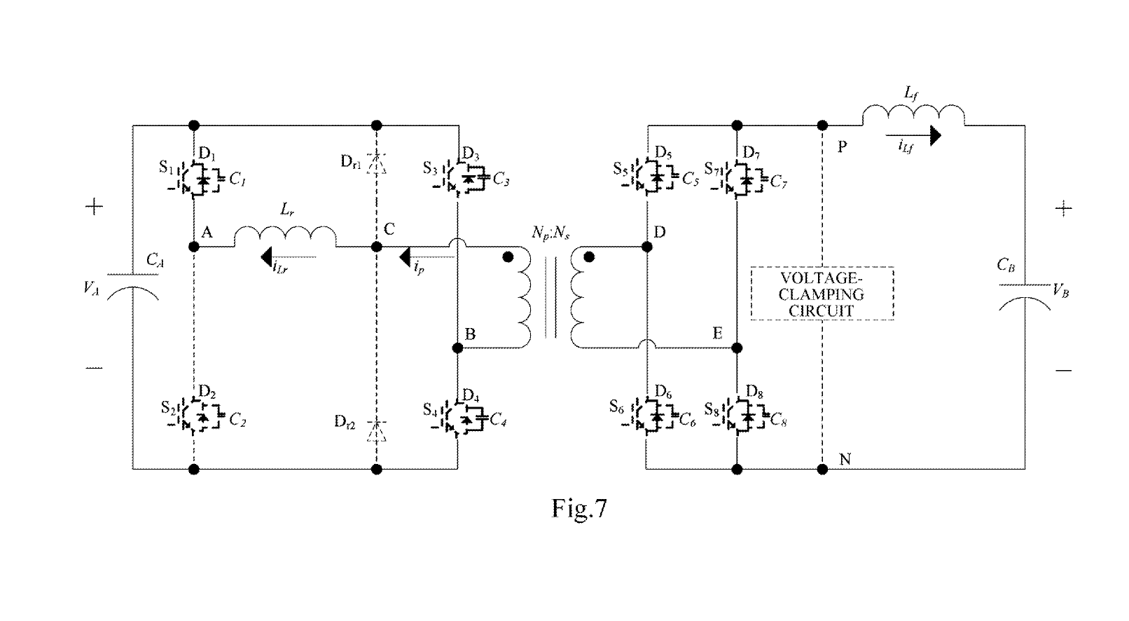

Switching state 2 [t₀˜t₁] (referring to FIG. 7)

As shown in FIG. 7, at the time of t₀, the switching component S₃ is turned off, the resonant inductor Lr charges the capacitor C₃, and the capacitor C₄ connected in parallel with the switching component S₄ is discharged.

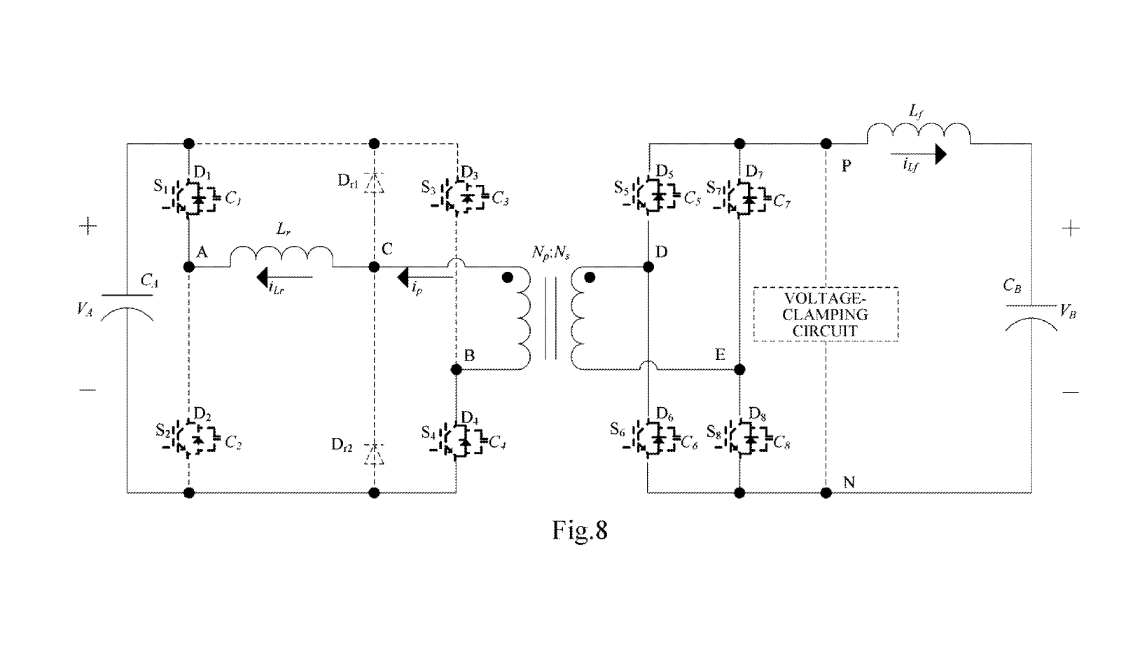

Switching state 3 [t₁˜t₂] (referring to FIG. 8)

As shown in FIG. 8, at the time of t₁, a voltage across the capacitor C₄ is discharged to zero, and when the discharge is completed, the anti-parallel diode D₄ of the switching component S₄ is turned on, and all of bus voltage at high-voltage side is applied to two terminals of the resonant inductor Lr so that the current through the resonant inductor Lr linearly declines. During this period, the switching component S₄ can be zero-voltage turned on.

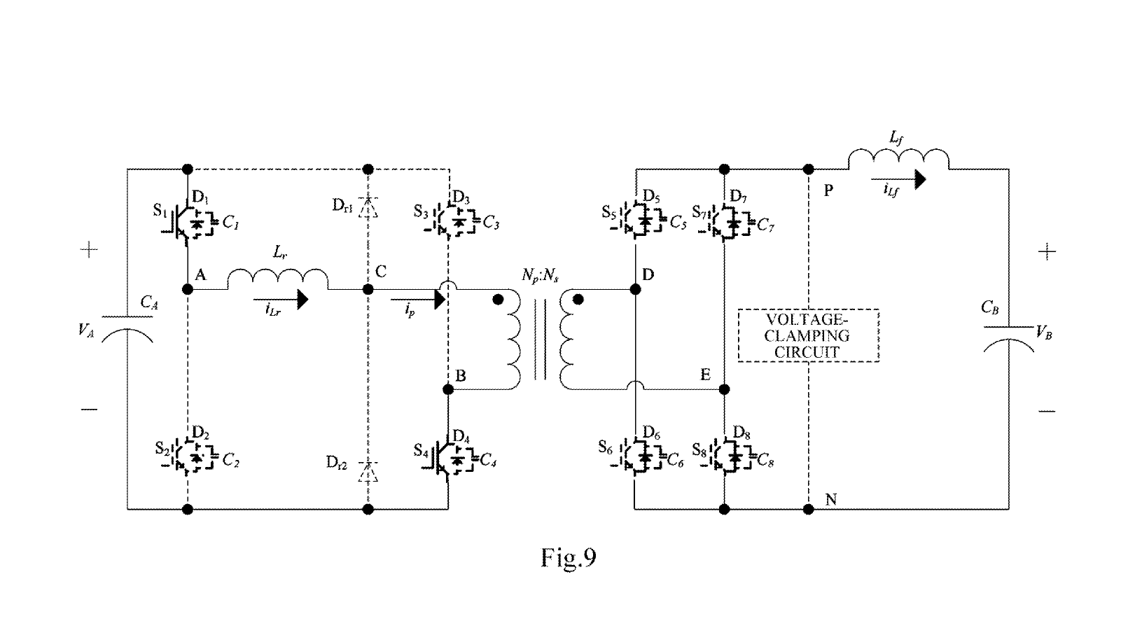

Switching state 4 [t₂˜t₃] (referring to FIG. 9)

As shown in FIG. 9, at the time of t₂, the current through the resonant inductor Lr drops to zero, and then linearly and reversely increases. The current is transferred to the switching component S₄ through the anti-parallel diode D₄.

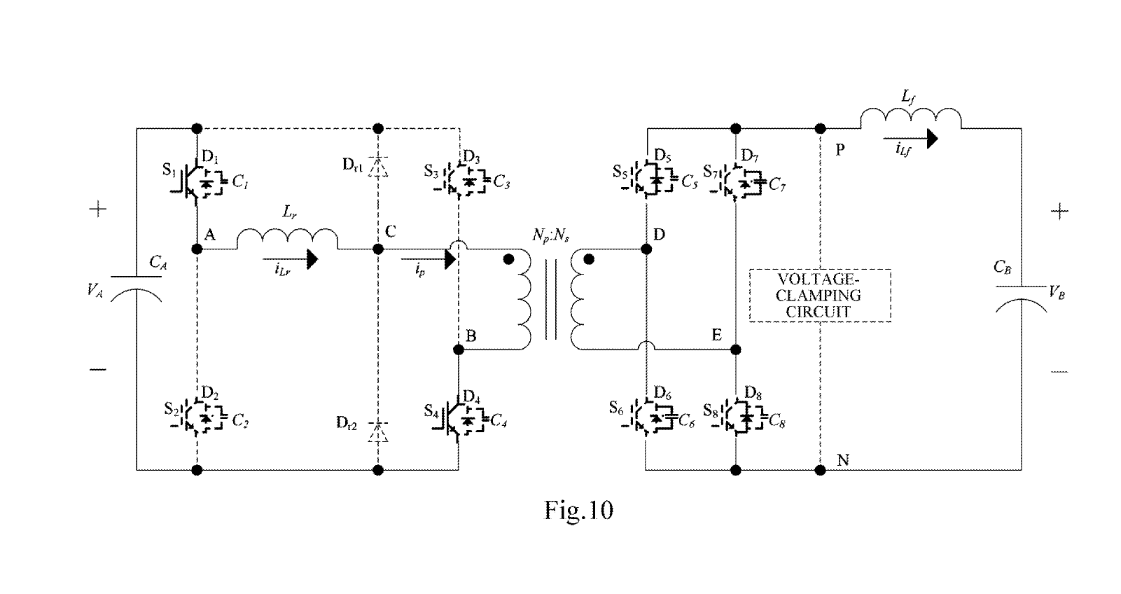

Switching state 5 [t₃˜t₄] (referring to FIG. 10)

As shown in FIG. 10, at the time of t₃, the current through the resonant inductor Lr increases to be equal to a current at the high-voltage side equivalent from the current through the filter inductor L_{f} (i.e., a current at the high-voltage side which is commuted according to the current through the filter inductor L_{f}). At this time, the anti-parallel diodes D₆ and D₇ of the switching components S₆ and S₇ at low-voltage side are off, and the capacitors C₆ and C₇ connected in parallel with the switching components S₆ and S₇ at low-voltage side are charged.

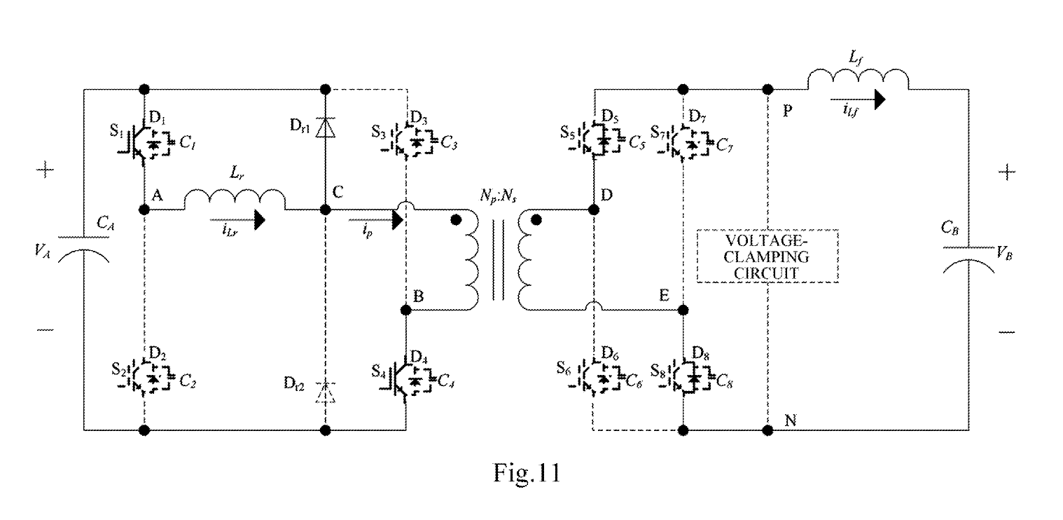

Switching state 6 [t₄˜t₅] (referring to FIG. 11)

As shown in FIG. 11, at the time of t₄, the capacitors C₆ and C₇ are completely charged, the current iₚ through the high-voltage side of the transformer is equal to a current equivalent from the low-voltage side. At this time, the current i_{Lr} through the resonant inductor Lr is larger than iₚ, the clamping diode Dᵣ₁ is on, and the current through the clamping diode Dᵣ₁ is a difference between the currents i_{Lr} and iₚ. The current i_{Lr} through the resonant inductor Lr remains unchanged and the current iₚ through the high-voltage side of the transformer increases.

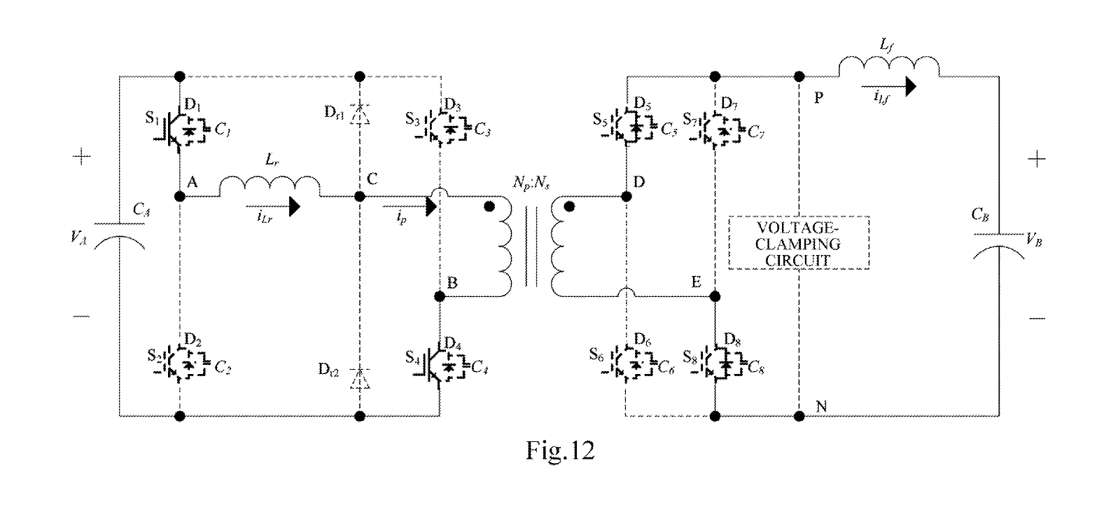

Switching state 7 [t₅˜t₆] (referring to FIG. 12)

As shown in FIG. 12, at the time of t₅, the current iₚ through the high-voltage side of the transformer increases to be equal to the current through the resonant inductor Lr, the clamping diode Dᵣ₁ is off, and the current iₚ through the high-voltage side of the transformer continues to increase.

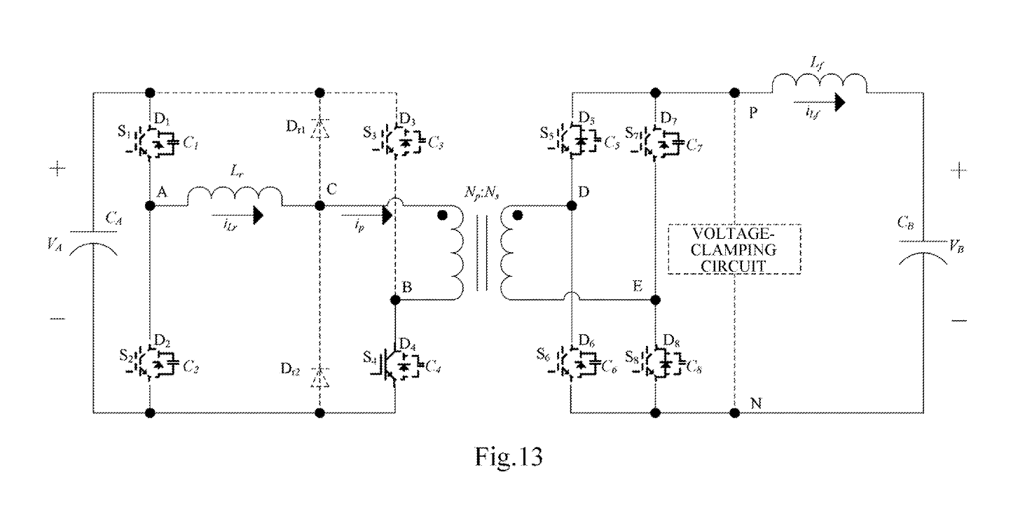

Switching state 8 [t₆˜t₇] (referring to FIG. 13)

As shown in FIG. 13, at the time of t₆, the switching component S₁ is turned off, the capacitor C₁ connected in parallel with the switching component S₁ is charged, the capacitor C₂ connected in parallel with the switching component S₂ is discharged, and the capacitors C₆ and C₇ at low-voltage side are discharged.

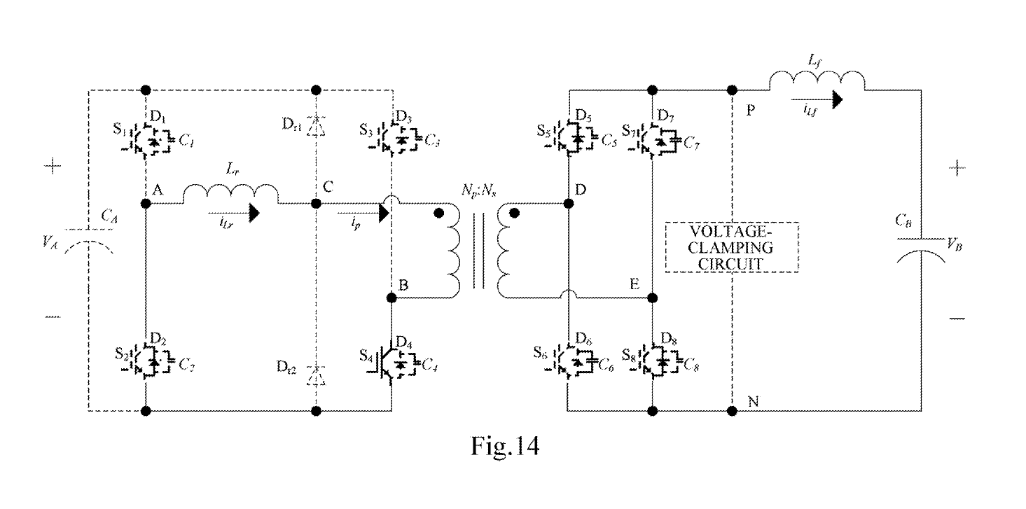

Switching state 9 [t₇˜t₈] (referring to FIG. 14)

As shown in FIG. 14, at the time of t₇, the capacitor C₁ is completely charged and the capacitor C₂ is completely discharged, the anti-parallel diode D₂ of the switching component S₂ is on, and the capacitors C₆ and C₇ at low-voltage side continue to discharge.

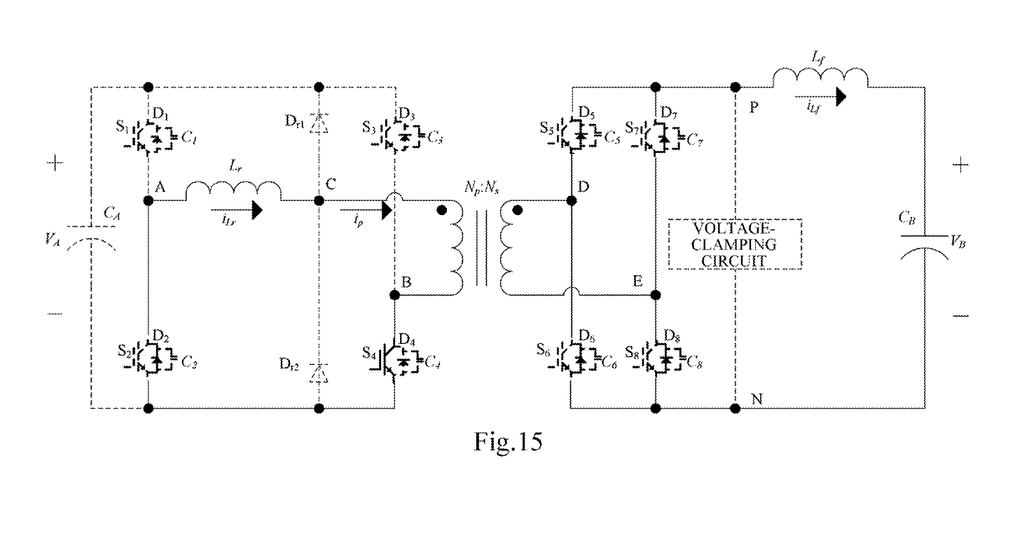

Switching state 10 [t₈˜t₉] (referring to FIG. 15)

As shown in FIG. 15, at the time of t₈, the capacitors C₆ and C₇ are completely discharged, and the anti-parallel diodes D₆ and D₇ are on. Thereafter, the current through the resonant inductor Lr remains unchanged, and during this period, the switching component S₂ is zero-voltage turned on.

Low-Voltage Side→High-Voltage Side:

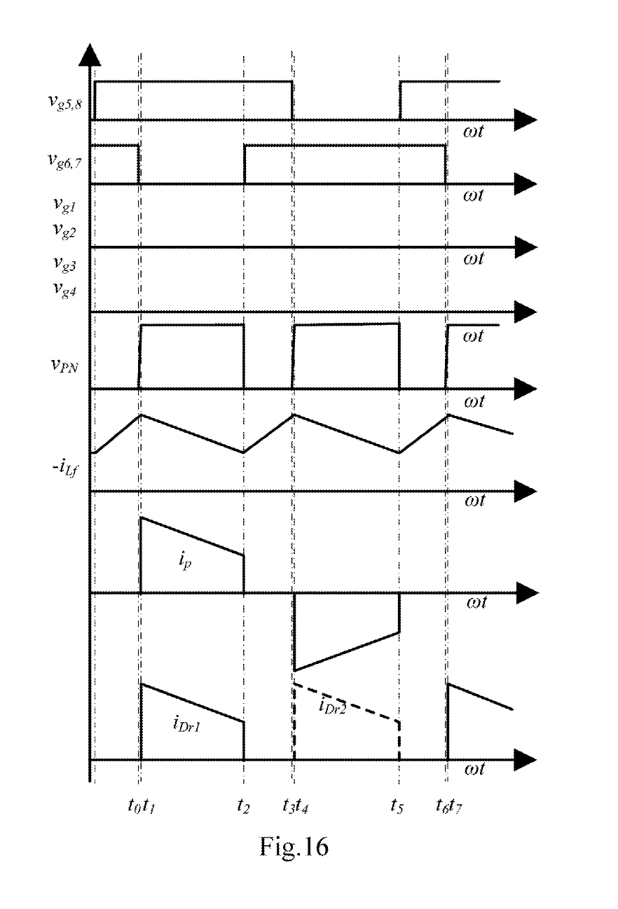

FIGS. 16-20 shows the operation principle that energy is transferred from the low-voltage side to the high-voltage side in the converter when the high-frequency switching signal is applied to a single side of the converter. With reference to FIG. 16, there are 12 switching states in the switching cycle when the high-frequency switching signal is only applied to the low-voltage side of the converter, and the switching states are respectively in the time periods of [before t₀], [t₀, t₁], [t₁, t₂], [t₂, t₃], [t₃, t₄], [t₄, t₅], [t₅, t₆], [t₆, t₇], [t₇, t₈], [t₈, t₉], [t₉, t₁₀], [t₁₀, t₁₁], and [t₁₁, t₁₂]. Although only the operating principle of the switching states in the time periods of [before t₀]-[t₂˜t₃] will be described herein, from the following described switching states, those skilled in the art may understand the operating principle of other switching states in the switching cycle.

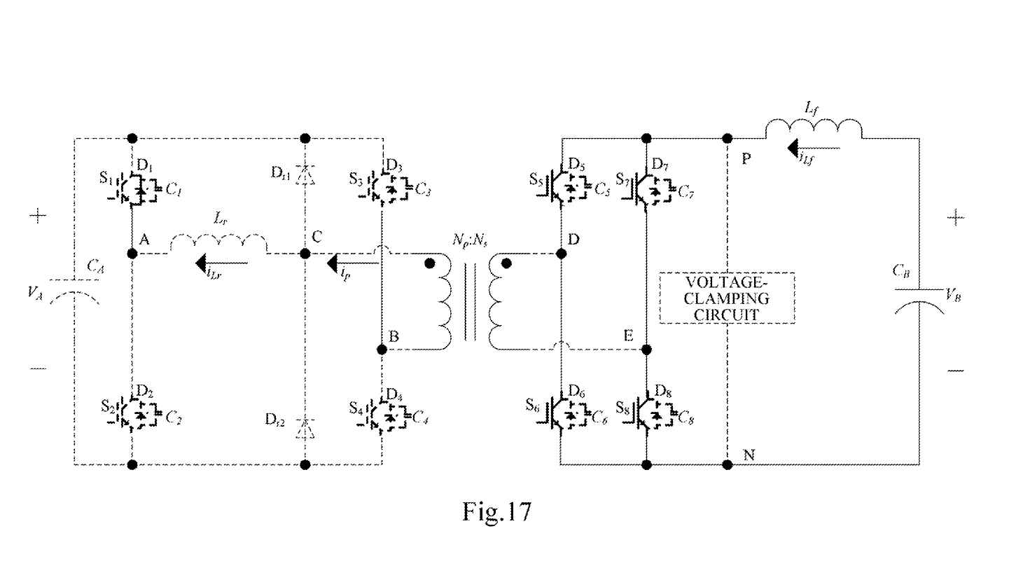

Switching state 1 [before t₀] (referring to FIG. 17)

As shown in FIG. 17, before the time of t₀, the switching components S₅˜S₈ at the low-voltage side are turned on simultaneously, and the current through the filtering inductor L_{f} increases. Both the currents through the high-voltage side of the transformer and the current through the resonant inductor Lr are zero.

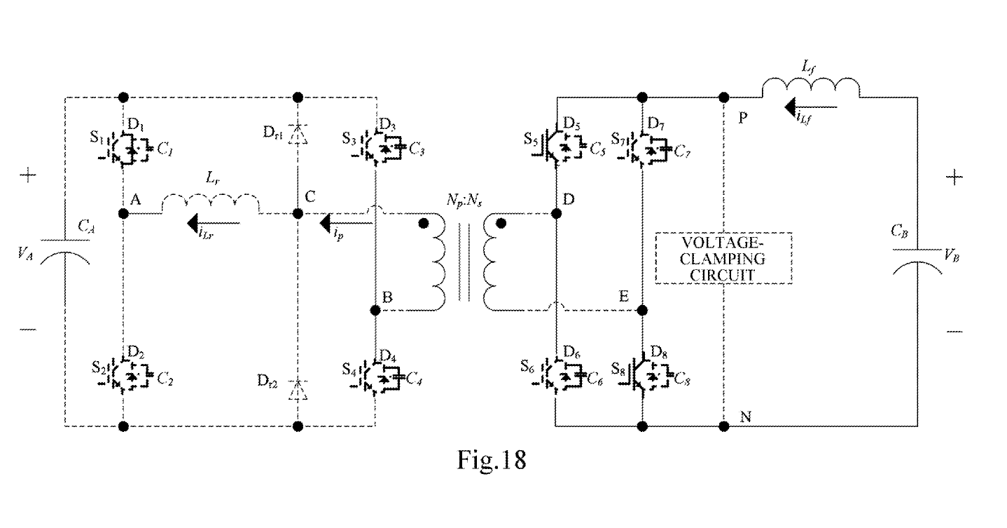

Switching state 2 [t₀˜t₁] (referring to FIG. 18)

As shown in FIG. 18, at the time of t₀, the switching components S₆ and S₇ are turned off, and the capacitors C₆ and C₇ connected in parallel with the switching component S₆ and S₇ are charged. Since a voltage at the primary side of the transformer commuted according to a voltage across the secondary side of the transformer is smaller than the bus voltage at the primary side of the transformer, there is no current through the high-voltage side of the transformer.

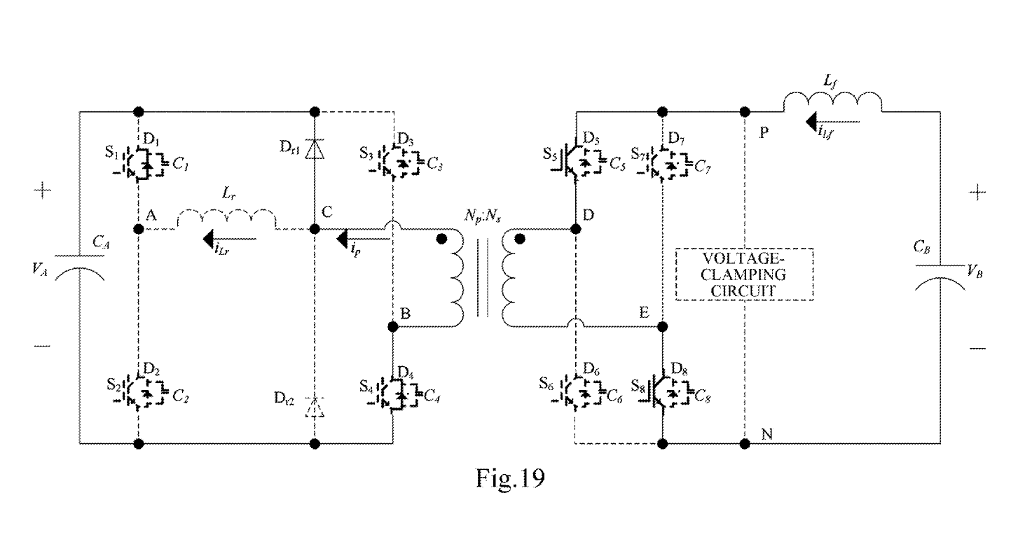

Switching state 3 [t₁˜t₂] (referring to FIG. 19)

As shown in FIG. 19, at the time of t₁, the capacitors C₆ and C₇ are completely charged, a voltage at the primary side commuted according to a voltage across the secondary side of the transformer is equal to the bus voltage at the primary side, and the clamping diode Dᵣ₁ is on.

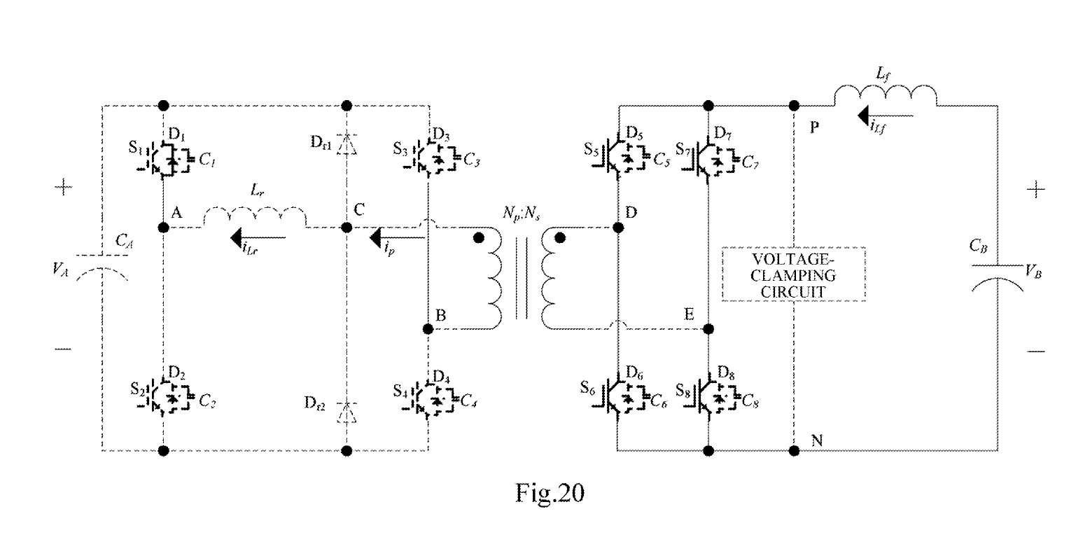

Switching state 4 [t₂˜t₃] (referring to FIG. 20)

As shown in FIG. 20, at the time of t₂, the switching components S₆ and S₇ are turned on, and the clamping diode Dᵣ₁ is off.

(2) an Example of Applying the Switching Signal to Two Sides

The situation where the high-frequency switching signal is simultaneously applied to two side of the converter, that is, the high-frequency switching signal is simultaneously applied to the switching components S₁˜S₈, will be described hereafter. The specific analysis of different switching states in a case of different transfer directions of energy will be given below.

High-Voltage Side→Low-Voltage Side:

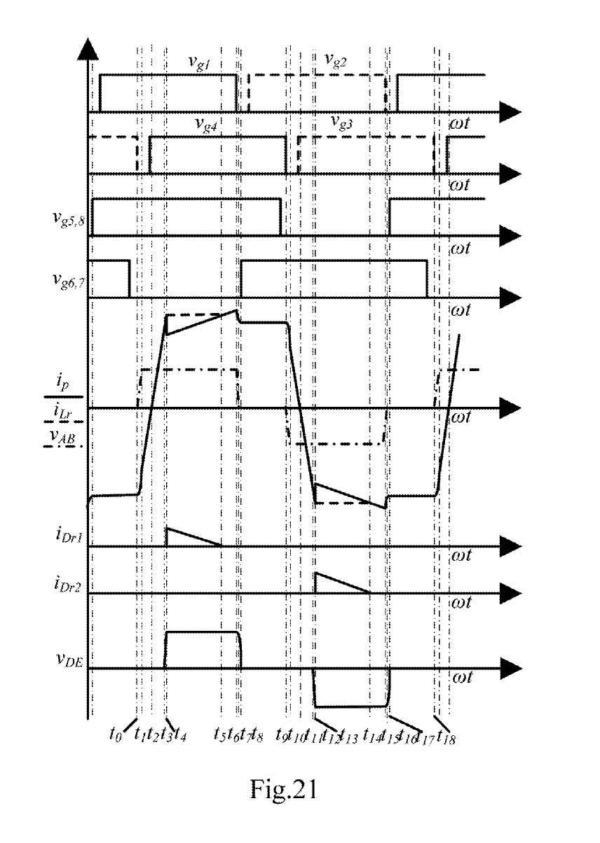

FIGS. 21-31 illustrates the operation principle that energy is transferred from the high-voltage side to the low-voltage side in the converter when the high-frequency switching signal is applied to two sides of the converter. With reference to FIG. 21, there are 18 switching states in the switching cycle when energy is transferred from the high-voltage side to the low-voltage side in the converter in the case of applying high-frequency switching signal to two sides of the converter, and the switching states are respectively in the time periods of [before t₀], [t₀, t₁], [t₁, t₂], [t₂, t₃], [t₃, t₄], [t₄, t₅], [t₅, t₆], [t₆, t₇], [t₇, t₈], [t₈, t₉], [t₉, t₁₀], [t₁₀, t₁₁], [t₁₁, t₁₂], [t₁₂, t₁₃], [t₁₃, t₁₄], [t₁₄, t₁₅], [t₁₅, t₁₆], [t₁₆, t₁₇], and [t₁₇, t₁₈]. Although only the operating principle of the switching states in the time periods of [before t₀]-[t₈˜t₉] will be described herein, from the following described switching states, those skilled in the art may understand the operating principle of other switching states in the switching cycle.

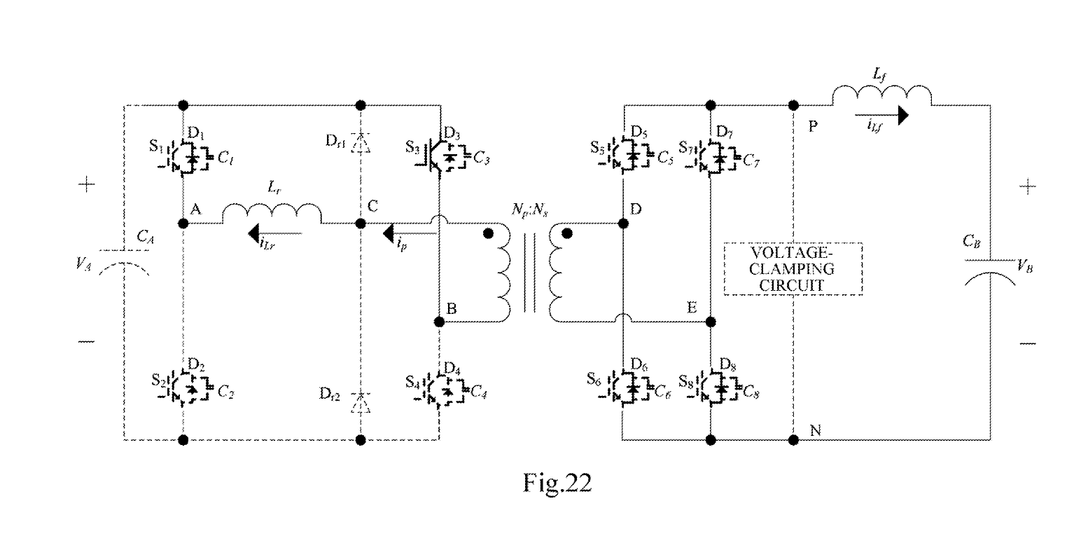

Switching state 1 [before t₀] (referring to FIG. 22)

As shown in FIG. 22, before the time of t₀, the switching components S₁ and S₃ are turned on, the current through the resonant inductor Lr flows through the anti-parallel diode D₁ of the switching component S₁ and the switching component S₃, and the current through the filter inductor L_{f} at low-voltage side flows through the anti-parallel diodes D₅˜D₈ of the switching components S₅-S₈ so as to provide continuous current. During this period, the switching components S₆ and S₇ are zero-voltage turned off.

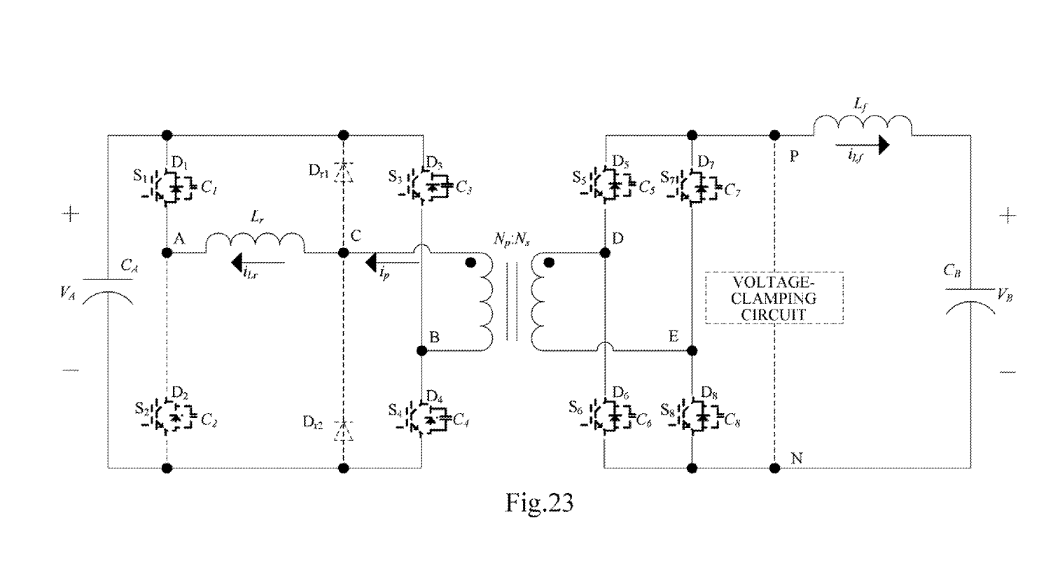

Switching state 2 [t₀˜t₁] (referring to FIG. 23)

As shown in FIG. 23, at the time of t₀, the switching component S₃ is turned off, the resonant inductor Lr charges the capacitor C₃ connected in parallel with the switching component S₃, and the capacitor C₄ connected in parallel with the switching component S₄ is discharged.

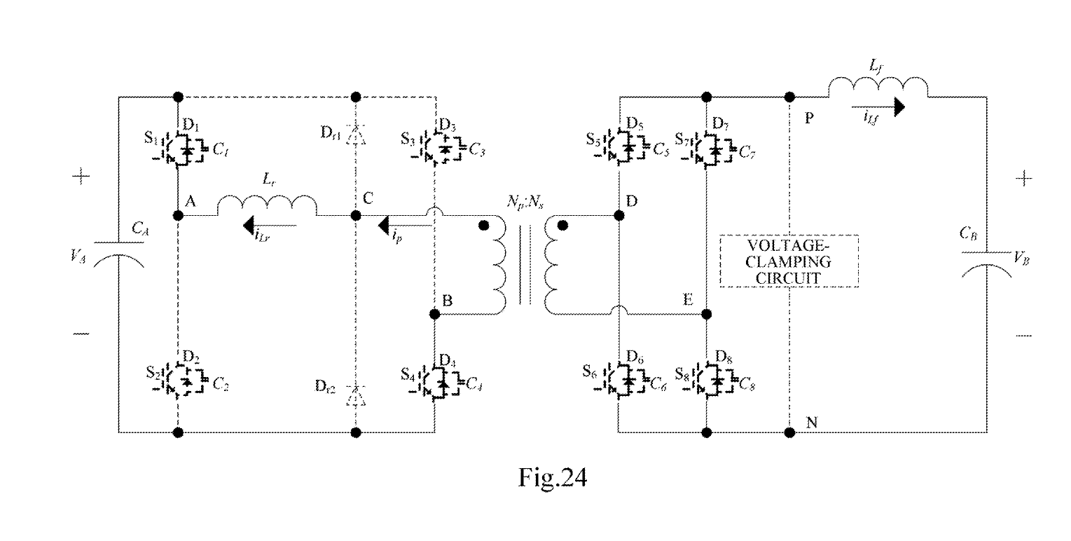

Switching state 3 [t₁˜t₂] (referring to FIG. 24)

As shown in FIG. 24, at the time of t₁, a voltage across the capacitor C₄ is discharged to zero and the discharge is completed, at this time, the anti-parallel diode D₄ of the switching component S₄ is on, and all of the bus voltage at high-voltage side is applied to two terminals of the resonant inductor Lr so that the current through the resonant inductor Lr declines linearly. During this period, the switching component S₄ can be zero-voltage turned on.

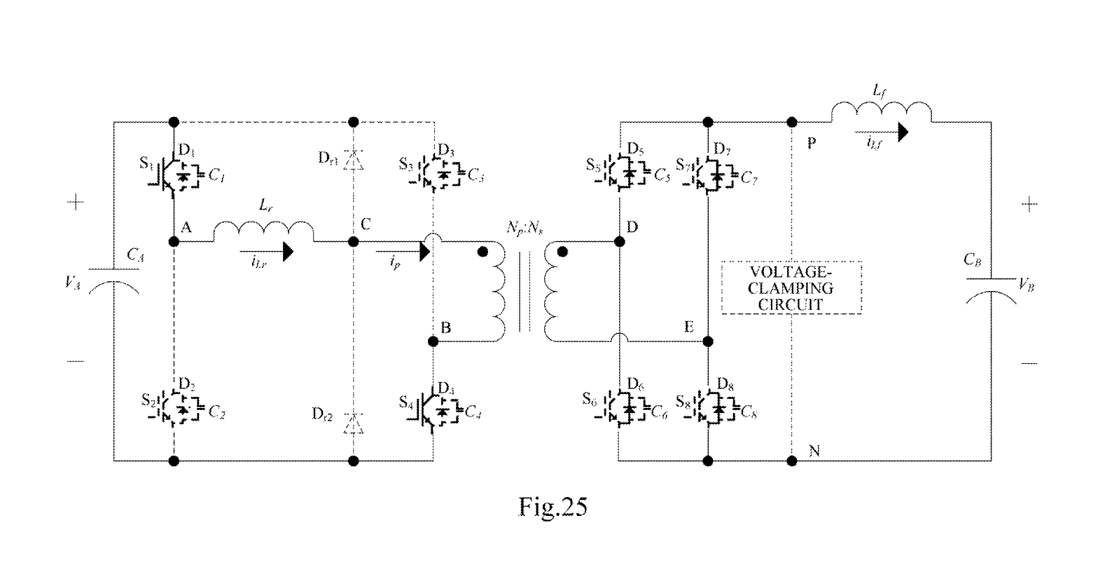

Switching state 4 [t₂˜t₃] (referring to FIG. 25)

As shown in FIG. 25, at the time of t₂, the current through the resonant inductor Lr drops to zero, and then increases reversely and linearly. The current is transferred to the switching component S₄ through the anti-parallel diode D₄.

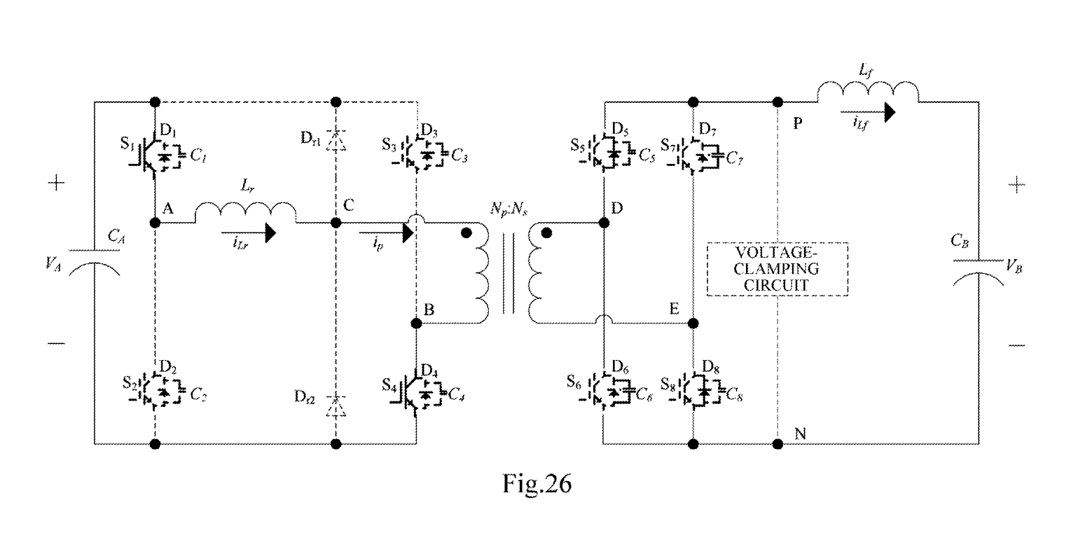

Switching state 5 [t₃˜t₄] (referring to FIG. 26)

As shown in FIG. 26, at the time of t₃, the current through the resonant inductor Lr increases to be equal to a current at the high-voltage side commuted according to the current through the filtering inductor L_{f}. At this time, the anti-parallel diodes D₆ and D₇ of the switching components S₆ and S₇ are off, and the capacitors C₆ and C₇ connected in parallel with the switching components S₆ and S₇ are charged.

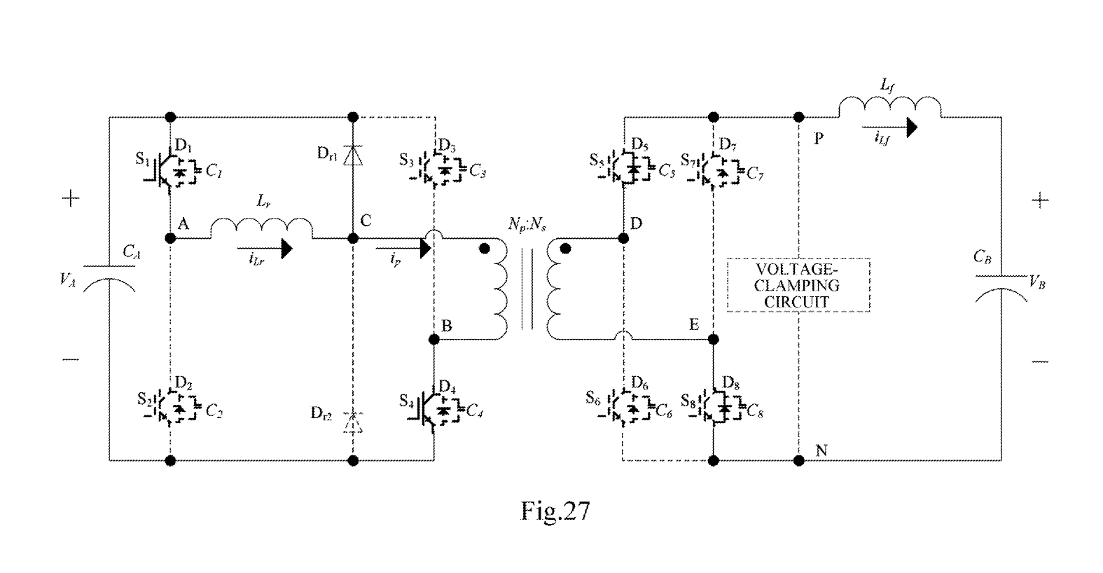

Switching state 6 [t₄˜t₅] (referring to FIG. 27)

As shown in FIG. 27, at the time of t₄, the capacitors C₆ and C₇ are completely charged, the current iₚ through the high-voltage side of the transformer is equal to a current commuted according to the low-voltage side. At this time, the current through the resonant inductor Lr is larger than iₚ, the clamping diode Dᵣ₁ is on, and the current through the clamping diode Dᵣ₁ is a difference between the currents i_{Lr} and iₚ. The voltage across the primary winding of the transformer is clamped to be the bus voltage at the primary side so that the off-state voltage across the switching components at the secondary side can be clamped, which may avoid off-state voltage spikes due to the inequality between the current at the secondary side commuted according to the current of the resonant inductor Lr and the current through the filtering inductor L_{f}. The current i_{Lr} through the resonant inductor Lr remains unchanged and the current iₚ through the high-voltage side of the transformer increases.

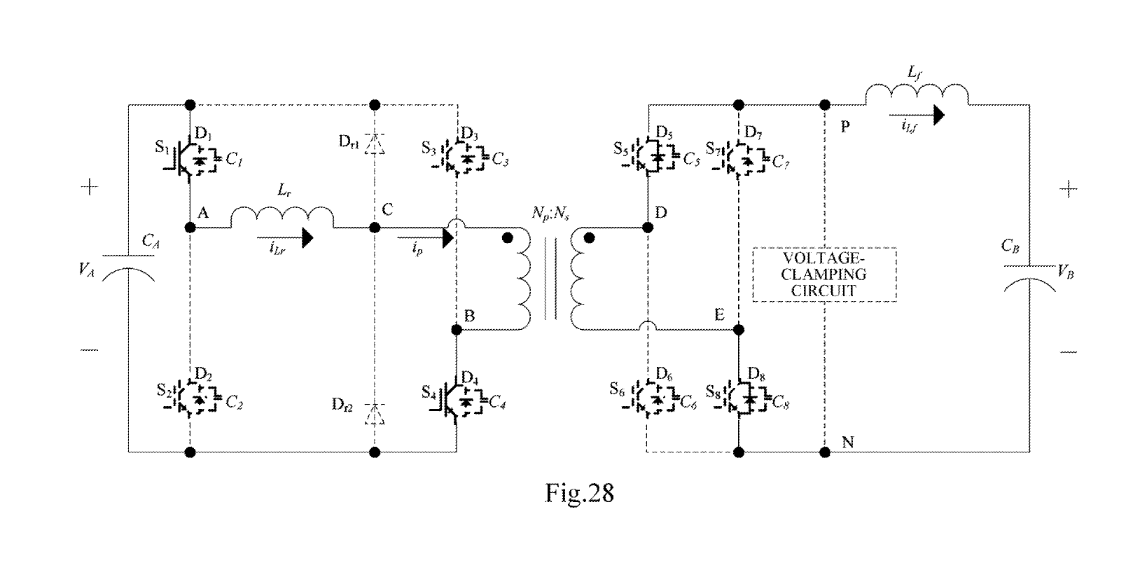

Switching state 7 [t₅˜t₆] (referring to FIG. 28)

As shown in FIG. 28, at the time of t₅, the current iₚ through the transformer at high-voltage side increases to be equal to the current through the resonant inductor Lr, the clamping diode Dᵣ₁ is off, and the current iₚ through the transformer at high-voltage side continues to increase.

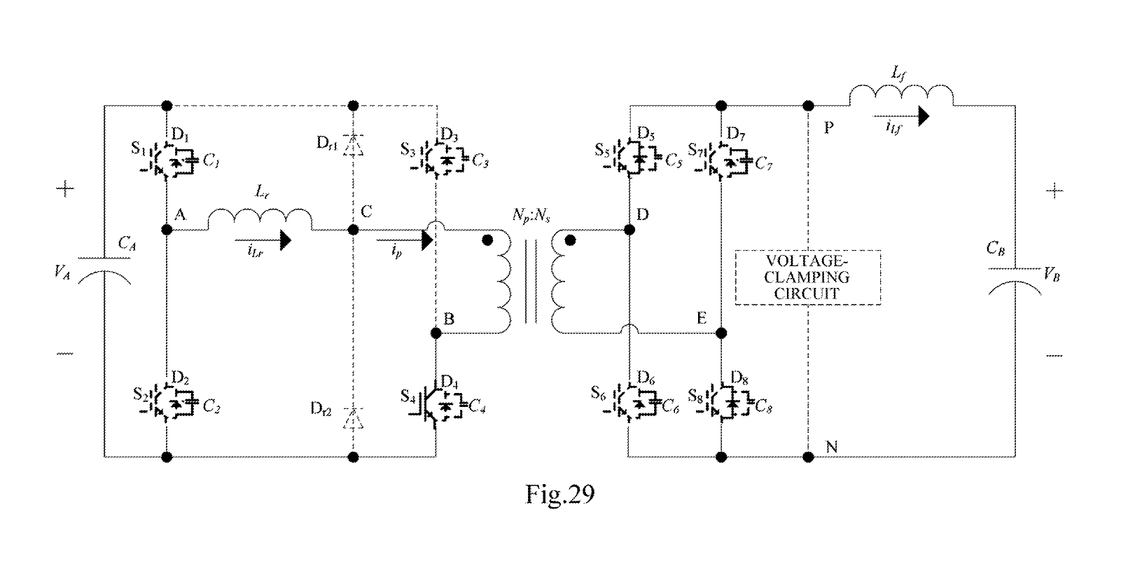

Switching state 8 [t₆˜t₇] (referring to FIG. 29)

As shown in FIG. 29, at the time of t₆, the switching component S₁ at the high-voltage side is turned off, the capacitor C₁ connected in parallel with the switching component S₁ is charged, the capacitor C₂ connected in parallel with the switching component S₂ is discharged, and the capacitors C₆ and C₇ at low-voltage side are discharged.

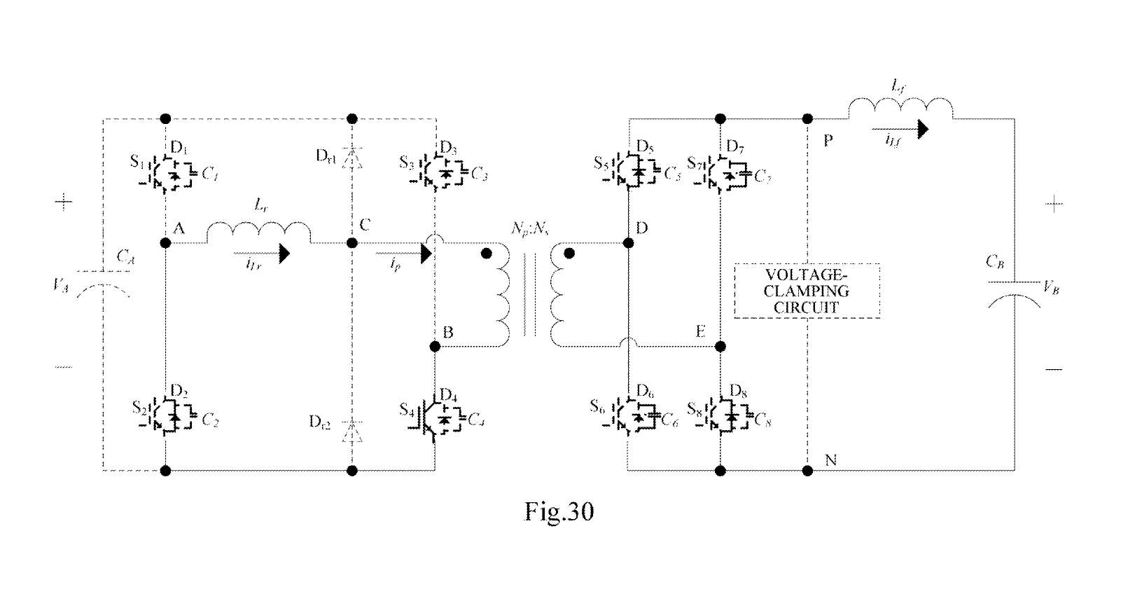

Switching state 9 [t₇˜t₈] (referring to FIG. 30)

As shown in FIG. 30, at the time of t₇, the capacitors C₁ and C₂ are respectively completely charged and discharged, the anti-parallel diode D₂ of the switching component S₂ is on, and the capacitors C₆ and C₇ at low-voltage side continue to discharge.

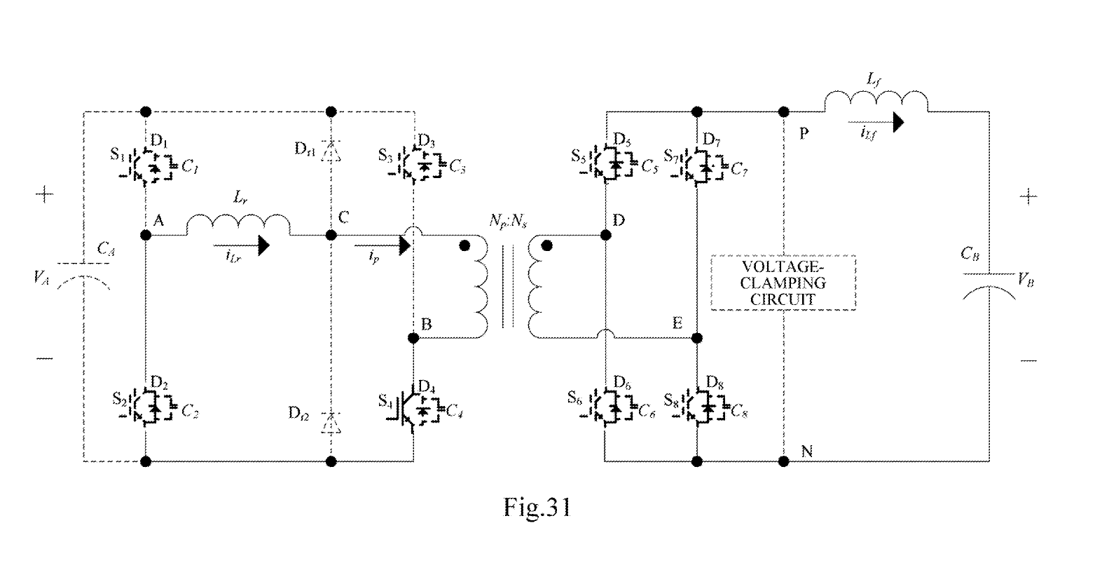

Switching state 10 [t₈˜t₉] (referring to FIG. 31) As shown in FIG. 31, at the time of t₈, the switching components S₆ and S₇ are turned on, the voltages across which are reduced to zero, and the anti-parallel diodes D₆ and D₇ are on. Thereafter, the current through the resonant inductor Lr remains unchanged, and during this period, the switching component S₂ is zero-voltage turned on.

Low-Voltage Side→High-Voltage Side:

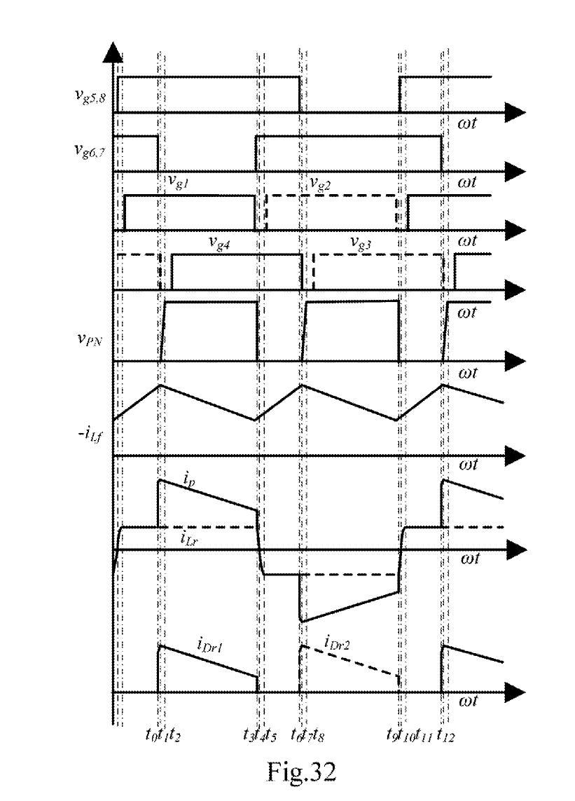

FIGS. 32-39 shows the operation principle that energy is transferred from the low-voltage side to the high-voltage side in the converter when the high-frequency switching signal is applied to two sides of the converter. With reference to FIG. 32, there are 12 switching states in the switching cycle when energy is transferred from the low-voltage side to the high-voltage side in the converter in the case of applying the high-frequency switching signal to two sides of the converter, and the switching states are respectively in the time periods of [before t₀], [t₀, t₁], [t₁, t₂], [t₂, t₃], [t₃, t₄], [t₄, t₅], [t₅, t₆], [t₆, t₇], [t₇, t₈], [t₈, t₉], [t₉, t₁₀], [t₁₀, t₁₁], and [t₁₁, t₁₂]. Although only the operating principle of the switching states in the time periods of [before t₀]-[t₅˜t₆] will be described herein, from the described switching states, those skilled in the art may understand the operating principle of other switching states in the switching cycle.

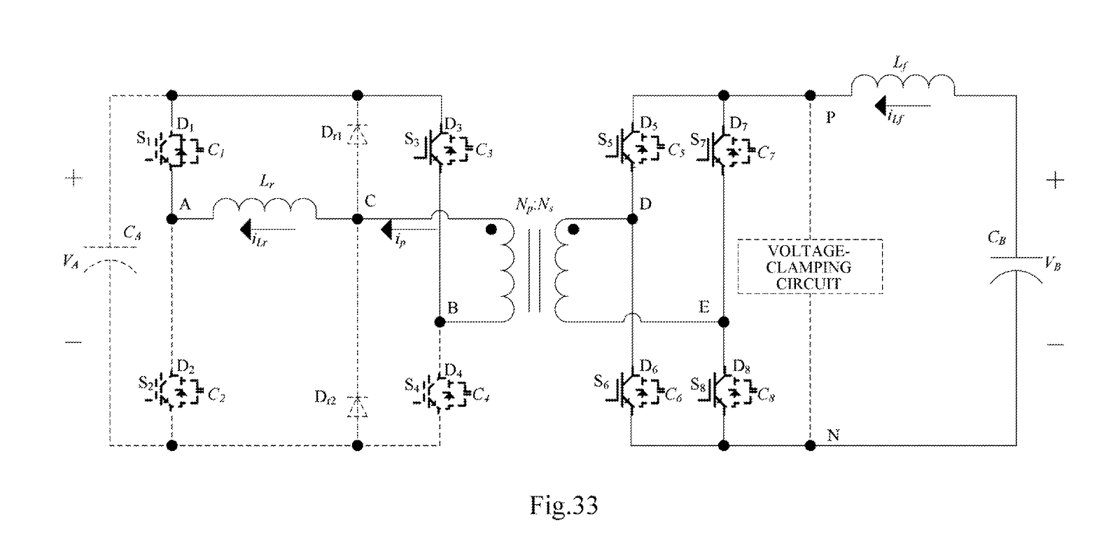

Switching state 1 [before t₀] (referring to FIG. 33)

As shown in FIG. 33, before the time of t₀, the switching components S₁ and S₃ at the high-voltage side are turned on, the current through the resonant inductor Lr flows through an anti-parallel diode D₁ of the switching component S₁ and the switching component S₃, the switching components S₅˜S₈ at the low-voltage side are turned on simultaneously, and the current through the filtering inductor L_{f} increases.

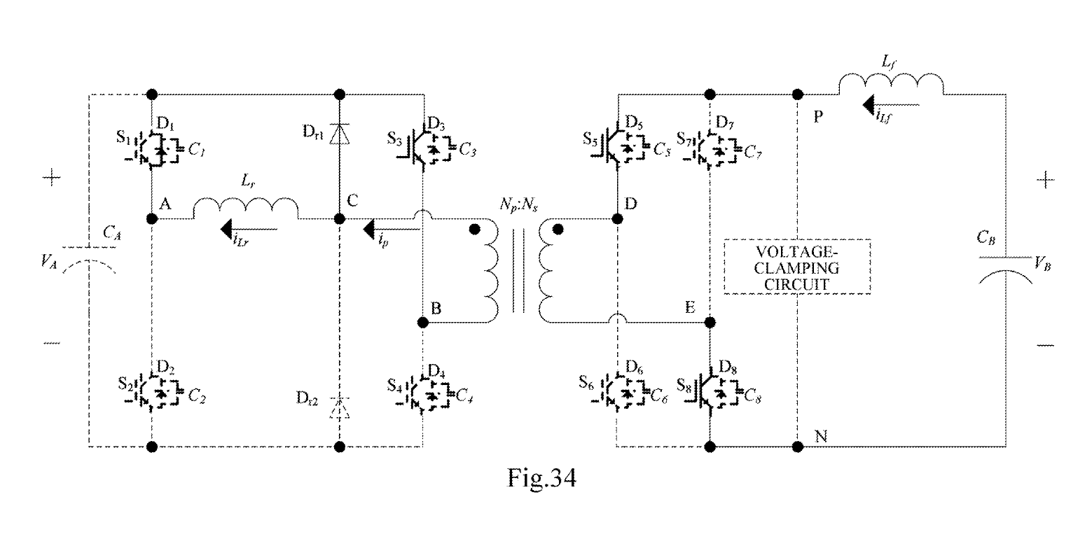

Switching state 2 [t₀˜t₁] (referring to FIG. 34)

As shown in FIG. 34, at the time of t₀, the switching component S₆ and S₇ are turned off, the clamping diode Dᵣ₁ is on, and the current through the clamping diode Dᵣ₁ is a difference between the currents iₚ and i_{Lr}. Since the clamping diode Dᵣ₁ and the switching component S₃ are turned on simultaneously, the primary winding of the transformer is short-circuited so that the off-state voltages of the switching components at the secondary side are clamped to zero and the switching components S₆ and S₇ are zero-voltage turned off.

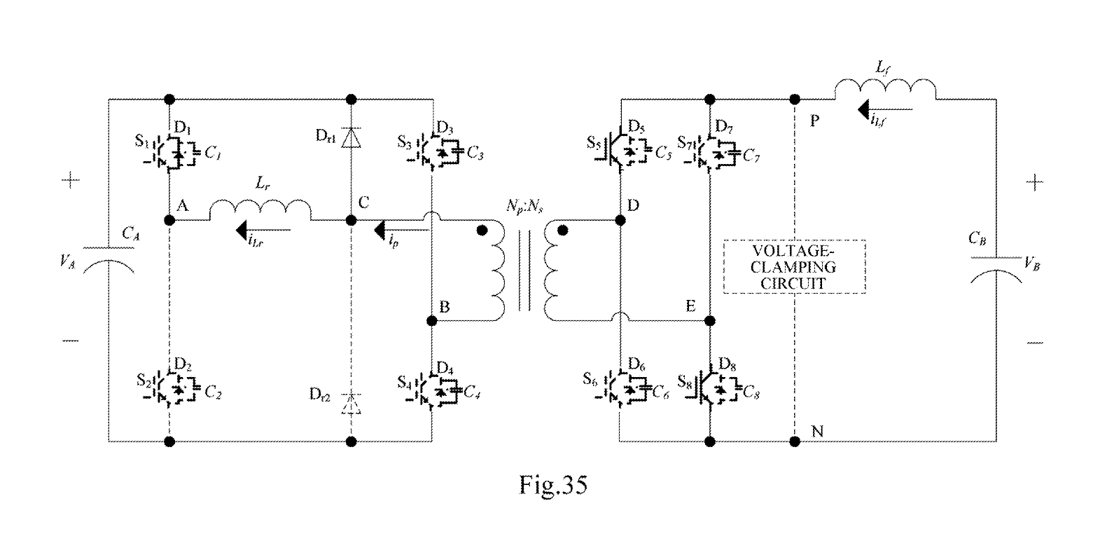

Switching state 3 [t₁˜t₂] (referring to FIG. 35)

As shown in FIG. 35, at the time of t₁, the switching component S₃ is turned off, the capacitor C₃ connected in parallel with the switching component S₃ is charged, the capacitor C₄ connected in parallel with the switching component S₄ is discharged, and the capacitors C₆ and C₇ at the low-voltage side are charged.

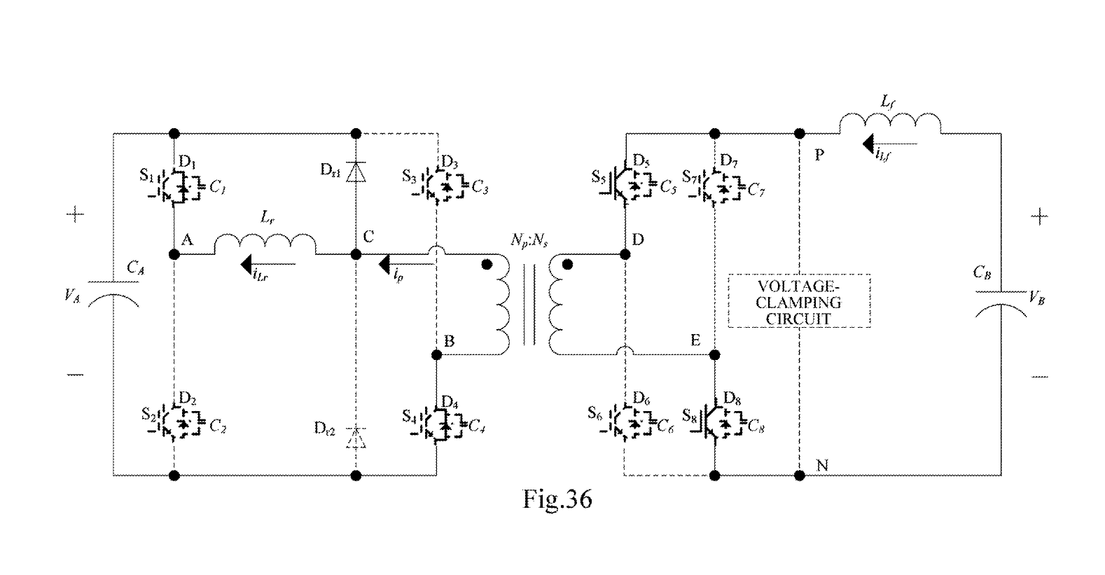

Switching state 4 [t₂˜t₃] (referring to FIG. 36)

As shown in FIG. 36, at the time of t₂, the capacitors are completely charged or discharged, and the anti-parallel diode D₄ of the switching component S₄ is on. During this period, the switching component S₄ is zero-voltage turned on, and the switching component S₁ is zero-voltage turned off since the current flows through the anti-parallel diode.

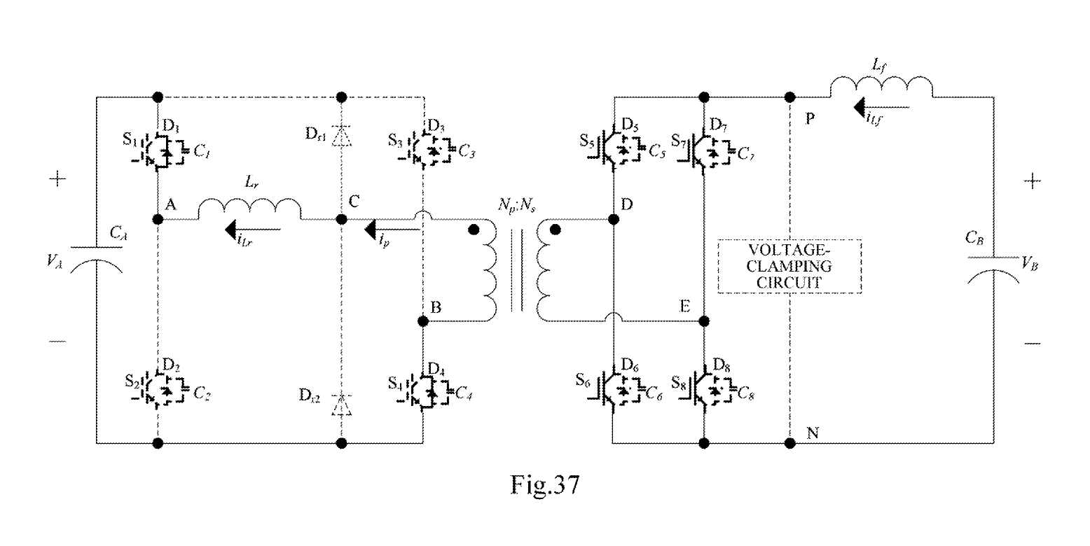

Switching state 5 [t₃˜t₄] (referring to FIG. 37)

As shown in FIG. 37, at the time of t₃, the switching components S₆ and S₇ are turned on, the voltage across the windings of the transformer is zero, and the clamping diode Dᵣ₁ is off. All of the bus voltage at the high-voltage side is completely applied to two terminals of the resonant inductor Lr, and thus the current through the resonant inductor Lr linearly declines.

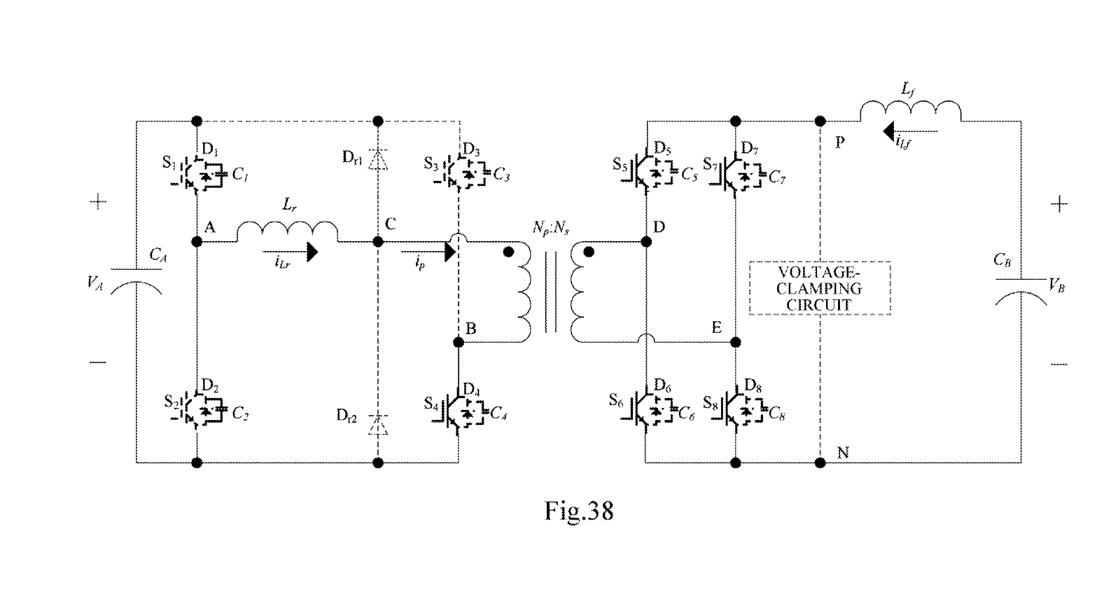

Switching state 6 [t₄˜t₅] (referring to FIG. 38)

As shown in FIG. 38, at the time of t₄, the current through the resonant inductor Lr drops to zero, the capacitor C₁ connected in parallel with the switching component S₁ is charged, the capacitor C₂ connected in parallel with the switching component S₂ is discharged, and the anti-parallel diode D₄ of the switching component S₄ is off.

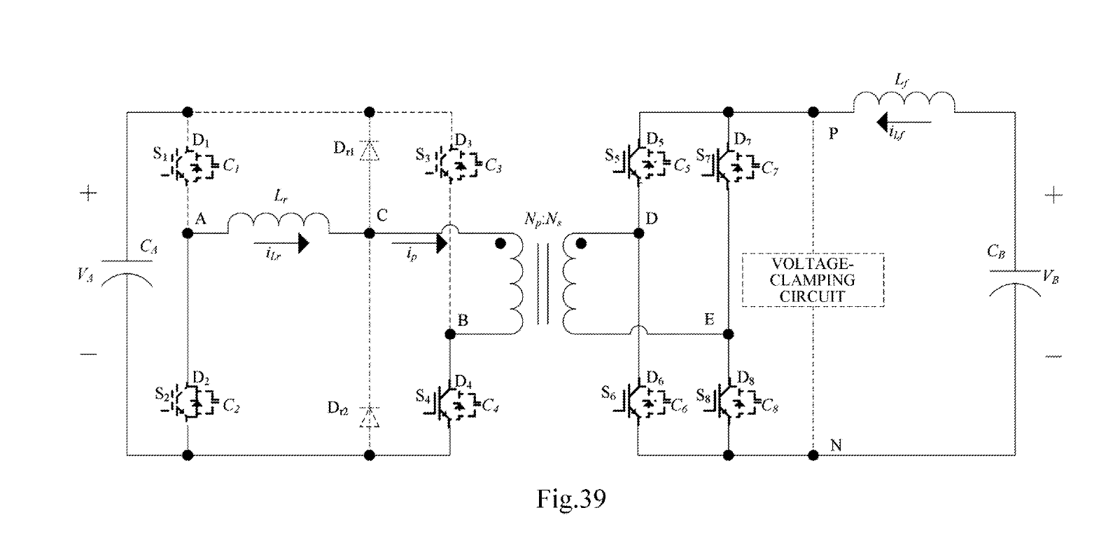

Switching state 7 [t₅˜t₆] (referring to FIG. 39)

As shown in FIG. 39, at the time of t₅, the capacitors C₁ and C₂ are completely charged and discharged respectively, and thereafter the current through the resonant inductor Lr remains unchanged.

From the above analysis of the operation states of the bi-directional DC-DC converter in the case of applying the high-frequency driving signal to a single side or two sides of the converter, the circuit topology of the present disclosure can achieve the soft switching (that is, zero-voltage or zero-current on and off) of the switching components, especially the switching components at the primary side, in the bidirectional DC-DC converter, thereby protecting the switching components and enables the leakage inductance of the transformer to be designed very small, which is conducive to improve transfer efficiency of the transformer and thus improve the total transfer efficiency of energy in the bi-directional DC-DC converter.

### Embodiment 2

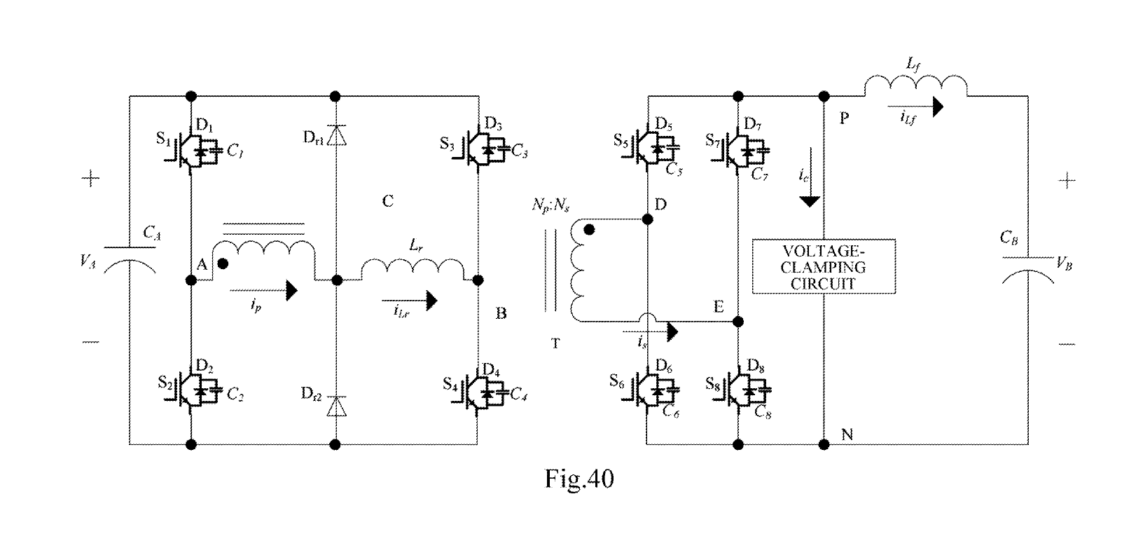

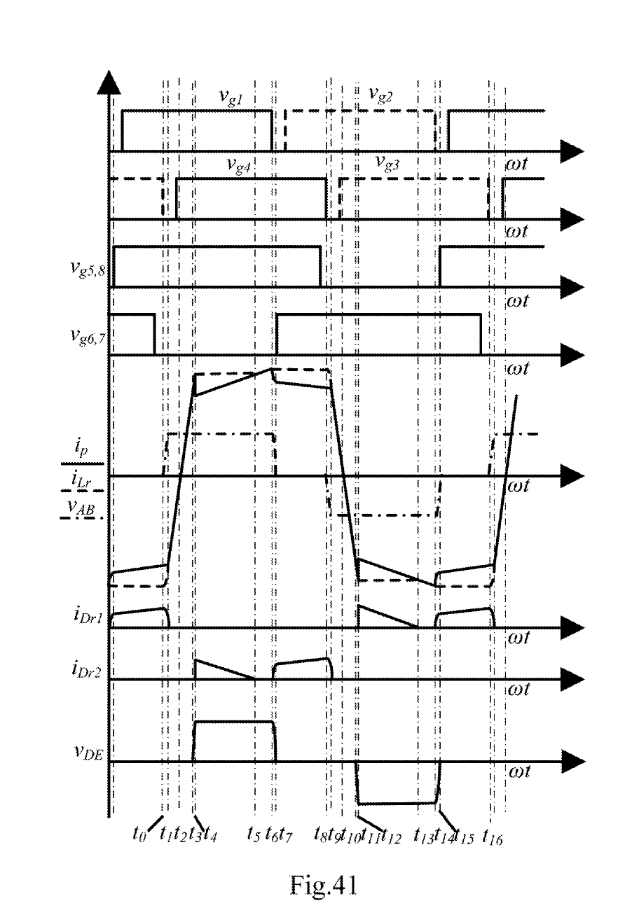

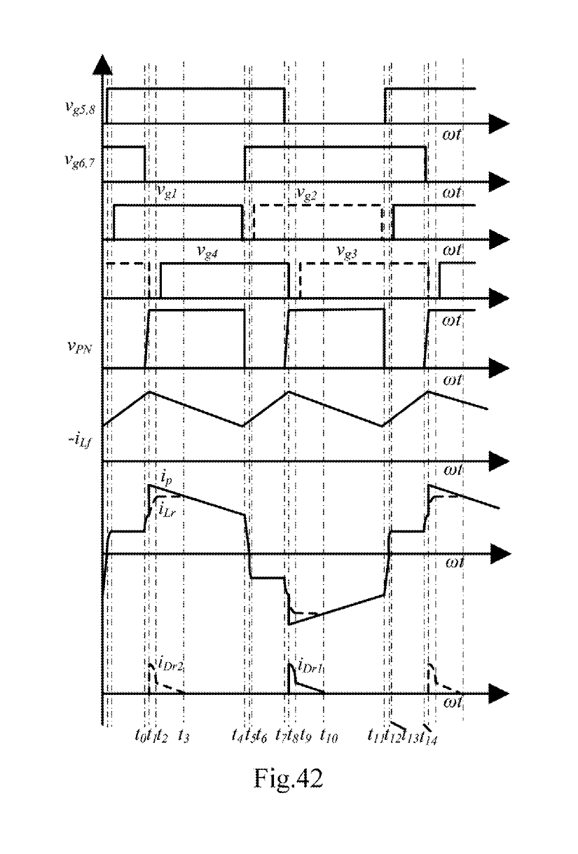

In the first embodiment, the operation states of the circuit topology in which two terminals of the isolated transformer at the primary side are connected to the lagging leg (that is, the first bridge arm composed of the switching components S₁ and S₂ in the primary-side inverting/rectifying module) has been described. In the second embodiment of the present disclosure, the isolated transformer may be connected to a leading leg, as shown in FIG. 40. The bi-directional DC-DC converter in the present embodiment has the circuit connections substantially identical to those in the first embodiment as shown in FIG. 2, except that the first bridge arm is composed of the switching components S₃ and S₄ connected in series, the second bridge arm is composed of the switching components S₁ and S₂ connected in series, and the second bridge arm is coupled to two terminals of the isolated transformer T at the primary side as a leading leg. Since the first bridge arm and the second bridge arm are equivalent to each other in terms of topology, the operation principle about the bi-directional DC-DC converter in this embodiment is substantially the same as that shown in FIG. 2. Thus the equivalent circuit diagrams of specific operation states in this embodiment will be omitted herein, and only the waveform diagrams of the circuit in the case of transferring energy from the high-voltage side to the low-voltage side and in the case of transferring energy from the low-voltage side to the high-voltage side will be provided respectively as shown in FIGS. 41 and 42. Hereafter, the operation state of this circuit topology will be described only in written description.

High-Voltage Side→Low-Voltage Side:

Switching state 1 [before t₀]

Before the time of t₀, the switching components S₁ and S₃ are turned on, the current through the resonant inductor Lr flows through the diode D₁ and the switching component S₃, and the difference between the current through the resonant inductor Lr and the current through the transformer flows through the clamping diode Dᵣ₁.

Switching state 2 [t₀˜t₁]

At the time of t₀, the switching component S₃ is turned off, the resonant inductor Lr charges the capacitor C₃, and the capacitor C₄ is discharged.

Switching state 3 [t₁˜t₂]

At the time of t₁, the capacitors C₃ and C₄ are completely charged and discharged respectively, the current through the resonant inductor Lr is transferred to the diode D₄, the DC voltage at the high-voltage side is applied to two terminals of the resonant inductor Lr, and the current through the resonant inductor Lr declines linearly. During this period, the switching component S₄ is zero-voltage turned on.

Switching state 4 [t₂˜t₃]

At the time of t₂, the current through the resonant inductor Lr drops to zero, and then increases reversely and linearly.

Switching state 5 [t₃˜t₄]

At the time of t₃, the current through the resonant inductor Lr increases to a current at high-voltage side commuted according to the current through the filtering inductor L_{f}, and the capacitors C₆ and C₇ are charged.

Switching state 6 [t₄˜t₅]

At the time of t₄, the capacitors C₆ and C₇ are completely charged, the current iₚ is equal to a current commuted according to the current through the filtering inductor L_{f}, and the difference between the current through the resonant inductor Lr and the current through the transformer flows through the clamping diode Dᵣ₂.

Switching state 7 [t₅˜t₆]

At the time of t₅, the current iₚ increases to be equal to the current through the resonant inductor Lr, and the clamping diode Dᵣ₂ is off.

Switching state 8 [t₆˜t₇]

At the time of t₆, the switching component S₁ is turned off, the capacitor C₁ is charged, the capacitor C₂ is discharged, the current iₚ drops, the clamping diode Dᵣ₂ is on, and the capacitors C₆ and C₇ are discharged.

Switching state 9 [t₇˜t₈]

At the time of t₇, the capacitor C₁ is completely charged, and the capacitors C₂, C₆, and C₇ are completely discharged.

Low-Voltage Side→High-Voltage Side:

Switching state 1 [before t₀]

Before the time of t₀, the switching components S₁ and S₃ are turned on, and the current through the resonant inductor Lr flows through the diode D₁ and the switching component S₃.

Switching state 2 [t₀˜t₁]

At the time of t₀, the switching components S₆ and S₇ are turned off, the capacitors C₆ and C₇ are charged, and the current through the resonant inductor Lr increases.

Switching state 3 [t₁˜t₂]

At the time of t₁, the capacitors C₆ and C₇ are charged such that the voltage across the capacitors C₆ and C₇ are equivalent to the voltage across the DC port at high-voltage side, the clamping diode Dᵣ₂ is on, and the current through the transformer is equal to a current at the high-voltage side commuted according to the current through the filtering inductor L_{f}. The switching component S₃ is turned off, the capacitor C₃ is charged, and the capacitor C₄ is discharged. The current through the clamping diode Dᵣ₂ is a difference between the current through the transformer and the current through the resonant inductor Lr.

Switching state 4 [t₂˜t₃]

At the time of t₂, the capacitor C₃ is completely charged and the capacitor C₄ is completely discharged, and the current through the resonant inductor Lr flows into the diode D₄. Thereafter, the switching component S₄ may be zero-voltage turned on.

Switching state 5 [t₃˜t₄]

At the time of t₃, the current iₚ through the transformer drops to be equal to the current through the resonant inductor Lr, and the clamping diode Dᵣ₂ is off. During this period, the switching component S₁ can be zero-voltage turned off.

Switching state 6 [t₄˜t₅]

At the time of t₄, the switching components S₆ and S₇ are turned on, the voltage of the transformer at the high-voltage side is applied to two terminals of the resonant inductor Lr, and the current through the resonant inductor Lr declines linearly.

Switching state 7 [t₅˜t₆]

At the time of t₅, the current through the resonant inductor Lr drops to zero, the capacitor C₁ is charged, and the capacitor C₂ is discharged.

Switching state 8 [t₆˜t₇]

At the time of t₆, the capacitor C₁ is completely charged and C₂ is completely discharged.

### Embodiment 3

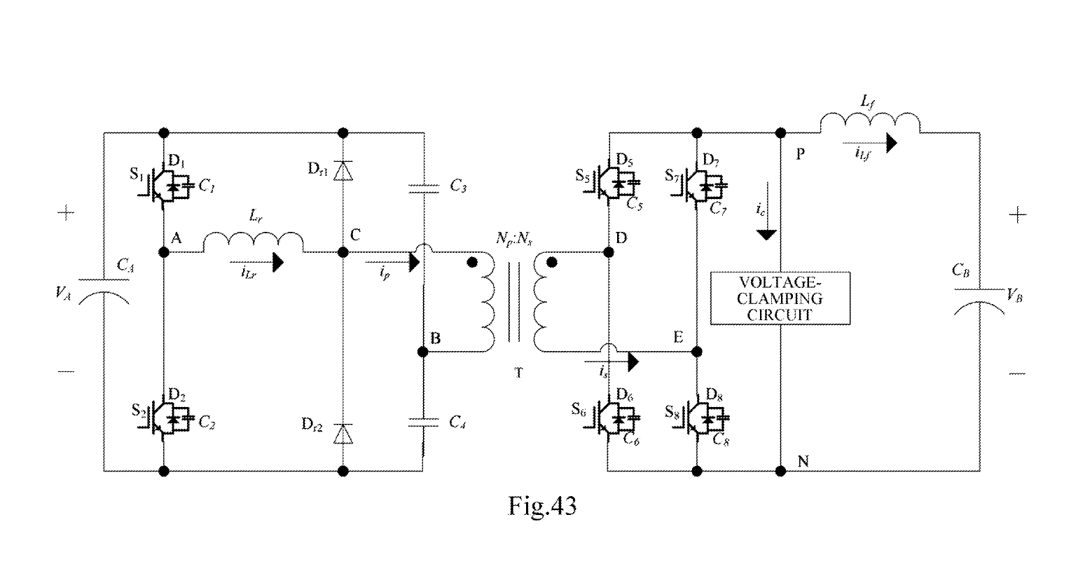

FIG. 43 shows a circuit topology diagram of a bi-directional DC-DC converter according to a third embodiment of the present disclosure. As shown in FIG. 43, the circuit topology of the bi-directional DC-DC converter in this embodiment is substantially identical to that in the bi-directional DC-DC converter shown in FIG. 2 except the primary-side inverting/rectifying module. In this embodiment, in addition to the first bridge arm and the clamping circuit shown in FIG. 2, the primary-side inverting/rectifying module further includes a capacitor bridge arm composed of capacitors C₃ and C₄ connected in series. The capacitor bridge arm, the first bridge arm, and the clamping bridge arm are connected in parallel with the DC port 1 at the primary side. One terminal of the primary winding of the transformer is connected to a midpoint C of the clamping bridge arm, and the other terminal thereof is connected to a midpoint B of the capacitor bridge arm.

Since the main circuit topology in this embodiment is substantially the same as that in the first embodiment, the description in detail will be omitted. Likewise, in this embodiment, a separate resonant inductor is provided and used in conjunction with a clamping circuit, thereby protecting switching components and enabling the leakage inductor of the transformer to be designed to a minimum. Thus, the transfer efficiency of the transformer can be improved and the total transfer efficiency of energy in the bi-directional DC-DC converter can be further improved.

### Embodiment 4

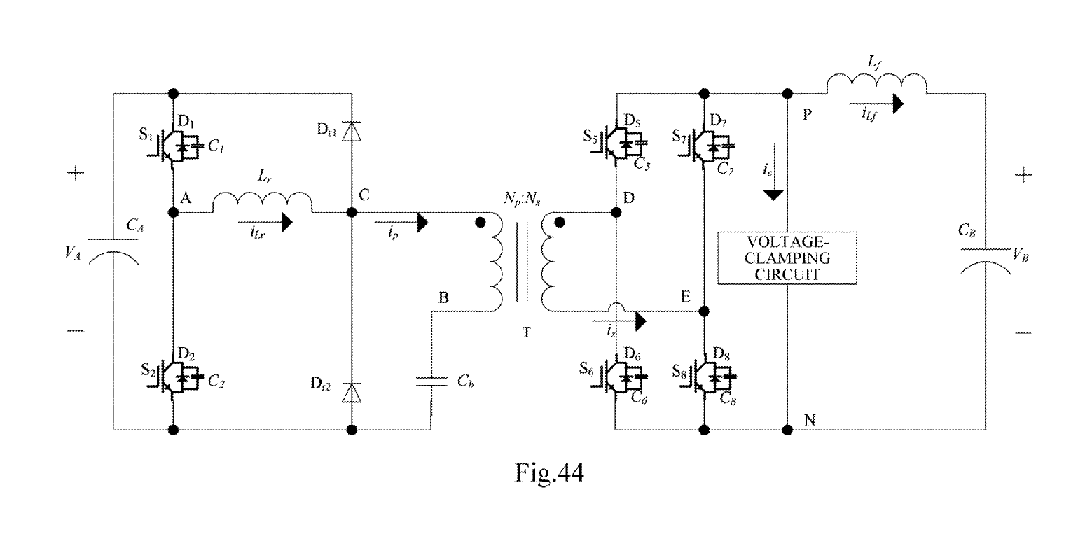

FIG. 44 shows a circuit topology diagram of a bi-directional DC-DC converter according to a fourth embodiment of the present disclosure. As shown in FIG. 44, the circuit topology of the bi-directional DC-DC converter in this embodiment is substantially identical to that in the bi-directional DC-DC converter shown in FIG. 2 except the primary-side inverting/rectifying module. In this embodiment, in addition to the first bridge arm and the clamping circuit shown in FIG. 2, the primary-side inverting/rectifying module further includes a capacitor branch composed of a capacitor C_{b}, wherein one terminal of the primary winding of the transformer is connected to the midpoint C of the clamping bridge arm and the other terminal thereof is connected to a terminal B of the capacitor C_{b}.

Similarly, since the main circuit topology in this embodiment is substantially the same as that in the first embodiment, the description in detail will be omitted. Likewise, in this embodiment, a separate resonant inductor is provided and used in conjunction with a clamping circuit, thereby protecting switching components and enabling the leakage inductor of the transformer to be designed to a minimum. Thus, the transfer efficiency of the transformer can be improved and the total transfer efficiency of energy in the bi-directional DC-DC converter can be further improved.

The embodiments were chosen and described in order to explain the principles of the disclosure and their practical applications so as to activate others skilled in the art to utilize the disclosure and various embodiments and with various modifications as are suited to the particular use contemplated. Alternative embodiments will become apparent to those skilled in the art to which the present disclosure pertains without departing from its spirit and scope. Accordingly, the scope of the present disclosure is defined by the appended claims rather than the foregoing description and the exemplary embodiments described therein.

What is claimed is:

1. A bi-directional DC-DC converter, comprising:
a primary-side inverting/rectifying module, two terminals of the primary-side inverting/rectifying module at a primary side being coupled to a first DC port, for receiving a DC power from the first DC port or outputting a DC power to the first DC port;
an isolated transformer comprising a primary winding and a secondary winding, two terminals of the primary winding being respectively coupled to two terminals of the primary-side inverting/rectifying module at a secondary side;
a secondary-side rectifying/inverting module comprising at least a switching component, wherein, two terminals of the secondary-side rectifying/inverting module at the primary side are respectively coupled to two terminals of the secondary winding, and two terminals of the secondary-side rectifying/inverting module at the secondary side are respectively coupled to a second DC port, and the secondary-side rectifying/inverting module is configured to rectify energy from the isolated transformer and output the rectified current to the second DC port, or receive a DC power from the second DC port;
wherein the primary-side inverting/rectifying module comprises a first bridge arm composed of a first switching component and a second switching component connected in series and a clamping circuit comprising a resonant inductor and a clamping bridge arm composed of a first semiconductor component and a second semiconductor component connected in series, and two terminals of the resonant inductor are respectively coupled to a common node of the first switching component and the second switching component and a common node of the first semiconductor component and the second semiconductor component.

2. The bi-directional DC-DC converter according to claim 1, wherein the resonant inductor is a separate inductor.

3. The bi-directional DC-DC converter according to claim 1, wherein the primary-side inverting/rectifying module further comprises a second bridge arm composed of a third component and a fourth component connected in series with each other, the second bridge arm is connected in parallel with the first bridge arm, and two terminals of the primary winding of the isolated transformer are respectively connected to a common node of the third component and the fourth component and a common node of the first semiconductor component and the second semiconductor component.

4. The bi-directional DC-DC converter according to claim 3, wherein the third component and the fourth component are semiconductor switching components which are controlled to be turned on and turned off, and the first bridge arm is a leading leg or a lagging leg.

5. The bi-directional DC-DC converter according to claim 3, wherein the third component and the fourth component are capacitor elements.

6. The bi-directional DC-DC converter according to claim 1, wherein the primary-side inverting/rectifying module further comprises a third capacitor, one terminal of which is connected to a common node of the second switching component and the second semiconductor component, and two terminals of the primary winding of the isolated transformer are respectively connected to the other terminal of the third capacitor and a common node of the first switching component and the second switching component.

7. The bi-directional DC-DC converter according to claim 1, wherein the first semiconductor component and the second semiconductor component are diodes, or semiconductor devices which are controlled to be turned on and turned off.

8. The bi-directional DC-DC converter according to claim 1, wherein the secondary-side rectifying/inverting module comprises a push-pull circuit or a full-bridge bi-directional rectifier circuit.

9. The bi-directional DC-DC converter according to claim 1, further comprising a voltage-clamping circuit connected in parallel with the secondary-side rectifying/inverting module, for absorbing voltage spike of the switching components in the secondary-side rectifying/inverting module.

10. The bi-directional DC-DC converter according to claim 8, further comprising a voltage-clamping circuit connected in parallel with the secondary-side rectifying/inverting module, for absorbing voltage spike of the switching components in the secondary-side rectifying/inverting module.

11. The bi-directional DC-DC converter according to claim 9, wherein the voltage-clamping circuit is a RCD clamping circuit.

12. The bi-directional DC-DC converter according to claim 1, further comprising a control circuit configured to generate and output a driving signal to the switching components in the primary-side inverting/rectifying module and the secondary-side rectifying/inverting module to control turn-on and turn-off of the switching components.

13. The bi-directional DC-DC converter according to claim 11, wherein the primary-side inverting/rectifying module is configured to receive a high-frequency driving signal and the secondary-side rectifying/inverting module receives a constant low-level driving signal, so that energy is transferred from the primary side to the second side.

14. The bi-directional DC-DC converter according to claim 11, wherein the primary-side inverting/rectifying module is configured to receive a constant low-level driving signal and the secondary-side rectifying/inverting module receives a high-frequency driving signal, so that energy is transferred from the second side to the primary side.

15. The bi-directional DC-DC converter according to claim 11, wherein the primary-side inverting/rectifying module and the secondary-side rectifying/inverting module are configured to receive a high-frequency driving signal.

16. The bi-directional DC-DC converter according to 12, wherein the control circuit comprises:
a sampling module configured to sample DC signals from the primary side and the secondary side in real time, and output a sampled signal;
a control module configured to receive the sampled signal from the sampling module, and compare the received sampled signal with a preset reference signal to generate a control signal;
a driving module configured to receive the control signal from the control module to generate the driving signal, and output the driving signal to the switching components in the primary-side inverting/rectifying module and the secondary-side rectifying/inverting module.

17. The bi-directional DC-DC converter according to claim 13, wherein the control circuit comprises:
a sampling module configured to sample DC signals from the primary side and the secondary side in real time, and output a sampled signal;
a control module configured to receive the sampled signal from the sampling module, and compare the received sampled signal with a preset reference signal to generate a control signal;
a driving module configured to receive the control signal from the control module to generate the driving signal, and output the driving signal to the switching components in the primary-side inverting/rectifying module and the secondary-side rectifying/inverting module.

18. The bi-directional DC-DC converter according to claim 14, wherein the control circuit comprises:
a sampling module configured to sample DC signals from the primary side and the secondary side in real time, and output a sampled signal;
a control module configured to receive the sampled signal from the sampling module, and compare the received sampled signal with a preset reference signal to generate a control signal;
a driving module configured to receive the control signal from the control module to generate the driving signal, and output the driving signal to the switching components in the primary-side inverting/rectifying module and the secondary-side rectifying/inverting module.

19. The bi-directional DC-DC converter according to claim 15, wherein the control circuit comprises:
a sampling module configured to sample DC signals from the primary side and the secondary side in real time, and output a sampled signal;
a control module configured to receive the sampled signal from the sampling module, and compare the received sampled signal with a preset reference signal to generate a control signal;
a driving module configured to receive the control signal from the control module to generate the driving signal, and output the driving signal to the switching components in the primary-side inverting/rectifying module and the secondary-side rectifying/inverting module.

20. The bi-directional DC-DC converter according to claim 1, further comprising a block capacitor connected in series with the primary winding.
